(19) United States
(12) Patent Application Publication
(10) Pub. No.: US 2025/0225413 A1
(43) Pub. Date: Jul. 10, 2025

(54) FIRST NODE, SECOND NODE, THIRD NODE AND METHODS PERFORMED THEREBY FOR HANDLING PREDICTIVE MODELS

(71) Applicant: Telefonaktiebolaget LM Ericsson (publ), Stockholm (SE)

(72) Inventors: Sumit SOMAN, Noida Uttar Pradesh (IN); Sunil Kumar VUPPALA, Bangalore (IN)

(73) Assignee: Telefonaktiebolaget LM Ericsson (publ), Stockholm (SE)

(21) Appl. No.: 18/850,937

(22) PCT Filed: Mar. 31, 2022
(86) PCT No.: PCT/IN2022/050323

§ 371 Date: Sep. 25, 2024

(51) Int. Cl. G06N 5/04

(52) U.S. Cl. CPC G06N 5/04

(57) ABSTRACT

A computer-implemented method, performed by a first node (111), for handling predictive models. The first node (111) updates (207), using machine learning, a first predictive model of an indicator of performance of the communications system (100). The updating (207) is based on respective explainability values respectively obtained from a first subset of a plurality of second nodes (112). The respective explainability values correspond to a first subset of respective second predictive models of the indicator of performance of the communications system (100), respectively determined by the first subset of the plurality of second nodes (112). The models in the first subset of respective second predictive models have a respective performance value above a threshold. The first node (111) then provides (208) an indication of the updated first predictive model to a third node (113) comprised in the plurality of second nodes (112) and excluded from the first subset, or to another node (114).

### TECHNICAL FIELD

The present disclosure relates generally to a first node and methods performed thereby, for handling predictive models. The present disclosure also relates generally to a second node and methods performed thereby, for handling predictive models. The present disclosure further relates generally to a third node and methods performed thereby, for handling predictive models.

### BACKGROUND

Computer systems in a communications network may comprise one or more nodes, which may also be referred to simply as nodes. A node may comprise one or more processors which, together with computer program code may perform different functions and actions, a memory, a receiving port and a sending port. A node may be, for example, a server. Nodes may perform their functions entirely on the cloud.

The performance of a communications network may be measured by the analysis of data indicating its performance, such as, for example, Key Performance Indicators (KPIs).

Federated Learning (FL) [1] has recently emerged as a paradigm for distributed model training without the need to share training data. Various Artificial Intelligence (AI)-enabled telecommunication use-cases may benefit from FL. An example is Managed Services for Networks (MSN), where use-cases may involve computing Key Performance Indicators (KPIs) from Performance Management (PM) counter data, training Machine Learning (ML) model(s) to predict a target Key Performance Indicator (KPI) using feature KPIs, and, using the trained models to predict the target KPI from online stream(s) of counter data. Based on the prediction(s) during configured Reporting Operating Periods (ROPs), an operator may execute actuation(s) to restore the target KPI, which may otherwise cause degradation in network performance and affect end-users.

Existing methods may train Machine Learning (ML) models for MSN use-cases for specific operators, technology, e.g., Third Generation (3G)/Fourth Generation (4G)/Fifth Generation (5G), geography or frequency band(s). However, distributed model training may not be performed as KPI, and PM, data may be understood to be private, and may not often be shared. FL may emerge as a viable approach to improving performance since many models may be understood to predict similar KPIs, and their aggregation using FL may update models with degraded performance, without the need to share data.

It may further be efficient to leverage FL at a cell, or location area, level, since actuation(s) to redress KPI degradations may be understood to be executed at cells. In this document, the term “local model(s)” may be used to refer to ML model(s) trained and deployed at such nodes, that is, client nodes, while the term “global model” may be used to refer to an ML model trained, or deployed, at a server node, whose parameters may be derived from one or more model(s) at the local nodes. Additionally, multiple global model(s) may exist when multiple target KPIs may need to be predicted, and each may be derived from respective local model(s) that may predict the same KPI.

Conventional FL approaches may involve aggregation of local models at a server node by simple Federated Averaging (FedAvg) to realize the global model, but this may have sub-optimal performance or slower convergence. Other strategies [2-3] may be computationally expensive. Some methods for training of predictive models have used drift detection and resolution mechanisms at local nodes [2], in conjunction with approaches such as Principal Components Analysis (PCA) and k-means clustering at local nodes [3] for handling drift in federated learning settings. These have in turn been used to determine the model update policy at the global node [3]. These methods may be computationally expensive to implement and may impact energy efficiency at scale. Causality in ML may be understood to involve understanding model predictions, that is, the effect, because of changes in underlying assumptions or data, that is, the cause. This principle may also be applied in an FL setting and it may be referred to as causal FL. Work on causal federated learning [6] may involve minimization of the loss computed from hidden layer representations from the participating client nodes. WO2021121585A1 and WO2021089429A2 are also examples of leveraging FL for distributed model training and Life-Cycle Management (LCM) use-cases in the telecommunications domain presenting alternative approaches, such as aggregation based on performance metrics or selector neural models. However, this approach may result in sub-optimal performance of the models.

### SUMMARY

As part of the development of embodiments herein, one or more challenges with the existing technology will first be identified and discussed.

The approaches for training of predictive models discussed in the Background section, or others performed on federated learning, do not leverage representations of explaining attributes of well performing local models in updating the global model to restore, or improve, local models with degraded performance.

In conventional FL, a global model M, with parameters denoted by w, may be updated at iteration (t+1) using the gradient gₖ computed from the loss function Fₖ at k client nodes, that may have models with parameters w^{k} trained on nₖ data samples, denoted as x^{k}, with corresponding target, that is, a label to be predicted by the model from the data, e.g., target KPI for MSN, denoted collectively by y^{k}, as follows:

$${w}_{( t + 1 )} ← {w}_{t} - η {\sum }_{k = 1}^{K} \frac{{n}_{k}}{n} {g}_{k} , where {g}_{k} = ∇ {F}_{k} ( {x}^{k} , {y}^{k} ; {w}^{k} )$$

The model parameters at all the local nodes may then be updated as w₍ₜ₊₁₎^{k}←wₜ−ηgₖ. Here, η may be understood to be a suitable learning rate, which may be a user-defined parameter, n may be understood to be the total number of samples at all local nodes, and ∇ may be understood to denote the gradient operator. The above equation may constitute an update policy.

It may be noted here that the global model may be updated based on the relative number of samples (nₖ/n) that may have been used to train the respective local model(s). Therefore, if a local model has been trained using many samples, it may dominate the global, and subsequently local, model updates, and eventually the performance. However, the global model update is not determined by the important attributes of the local models that are performing well. Further, multiple iterations may be needed for convergence of local and global model training, that is, parameter updates, which may increase compute requirements such as energy compute requirements, especially when many local nodes are involved, such as when FL may be implemented for a cell-level MSN use-case.

These problems with existing solutions motivate requirements that may be summarized as follows. For scalable FL, models, global and local, may be understood to need to generalize quickly on data representations. Also, energy efficiency may be understood to be needed, e.g., compute cost, number of iterations etc. Further, a global model update mechanism, may be understood to need to capture representative attributes that may be able to determine predictions of well performing local models. It may be understood that the explaining attributes of the models in an FL setup, e.g., as determined in [5], may change based on the update policies and incoming data streams.

It is an object of embodiments herein to improve the handling of predictive models. In a scenario where FL is employed at cell-level for MSN, an FL strategy may be required that may quickly update local models having degraded performance using parameters of the global model for that KPI with better performance, while also requiring less computation, e.g., faster convergence of training loss function with fewer iterations, to determine such a global model. This may be understood to be also important from an energy-efficiency perspective of such federated model training systems, even for other use cases.

According to a first aspect of embodiments herein, the object is achieved by a computer-implemented method performed by a first node. The method is handling predictive models. The first node operates in a communications system. The first node updates, using machine learning a first predictive model of an indicator of performance of the communications system. The updating is based on respective explainability values respectively obtained from a first subset of a plurality of second nodes operating in the communications network. The respective explainability values correspond to a first subset of respective second predictive models of the indicator of performance of the communications system, respectively determined by the first subset of the plurality of second nodes. The models in the first subset of respective second predictive models have a respective performance value above a threshold. The first node then provides an indication of the updated first predictive model to a third node comprised in the plurality of second nodes and excluded from the first subset, or to another node operating in the communications system.

According to a second aspect of embodiments herein, the object is achieved by a computer-implemented method performed by a third node. The method is for handling predictive models. The third node operates in a communications system. The third node receives the indication from the first node operating in the communications system. The indication indicates the updated first predictive model of the indicator of performance of the communications system. The updated first predictive model is based on the respective explainability values respectively obtained from the first subset of the plurality of second nodes operating in the communications network. The respective explainability values correspond to the first subset of the respective second predictive models of the indicator of performance of the communications system, respectively determined by the first subset of the plurality of second nodes. The models in the first subset of respective second predictive models have the respective performance value above the threshold. The respective second predictive model of the indicator of performance of the communications system of the third node has the respective performance value below the threshold. The third node is comprised in the plurality of second nodes but excluded from the first subset of the plurality of second nodes. The third node also replaces the respective second predictive model of the indicator of performance of the communications system of the third node with the updated first predictive model indicated by the received indication.

According to a third aspect of embodiments herein, the object is achieved by a computer-implemented method performed by a second node. The method is for handling predictive models. The second node operates in a communications system. The second node sends, to the first node operating in the communications system, the respective explainability values corresponding to the respective second predictive model of the indicator of performance of the communications system. The respective second predictive model has been determined by the second node. The respective second predictive model has a respective performance value above the threshold.

According to a fourth aspect of embodiments herein, the object is achieved by the first node. The first node is for handling predictive models. The first node is configured to operate in the communications system. The first node is configured to update, using machine learning, the first predictive model of the indicator of performance of the communications system. The updating is configured to be based on the respective explainability values configured to be respectively obtained from the first subset of the plurality of second nodes configured to be operating in the communications network. The respective explainability values are configured to correspond to the first subset of respective second predictive models of the indicator of performance of the communications system, configured to be respectively determined by the first subset of the plurality of second nodes. The models in the first subset of respective second predictive models have the respective performance value above the threshold. The first node is also configured to provide the indication of the first predictive model configured to be updated to the third node configured to be comprised in the plurality of second nodes and excluded from the first subset, or to the another node configured to operate in the communications system.

According to a fifth aspect of embodiments herein, the object is achieved by the third node. The third node is for handling predictive models. The third node is configured to operate in the communications system. The third node is configured to receive the indication from the first node configured to operate in the communications system. The indication is configured to indicate the updated first predictive model of the indicator of performance of the communications system. The updated first predictive model is configured to be based on the respective explainability values configured to be respectively obtained from the first subset of the plurality of second nodes configured to operate in the communications network. The respective explainability values are configured to correspond to the first subset of respective second predictive models of the indicator of performance of the communications system, configured to be respectively determined by the first subset of the plurality of second nodes. The models in the first subset of respective second predictive models are configured to have the respective performance value above the threshold. The respective second predictive model of the indicator of performance of the communications system of the third node is configured to have the respective performance value below the threshold. The third node is configured to be comprised in the plurality of second nodes but excluded from the first subset of the plurality of second nodes. The third node is also configured to replace the respective second predictive model of the indicator of performance of the communications system of the third node with the updated first predictive model configured to be indicated by the indication configured to be received.

According to a sixth aspect of embodiments herein, the object is achieved by the second node. The second node is for handling predictive models. The second node is configured to operate in the communications system. The second node is further configured to send, to the first node configured to operate in the communications system, the respective explainability values configured to correspond to the respective second predictive model of the indicator of performance of the communications system. The respective second predictive model is configured to have been determined by the second node. The respective second predictive model is configured to have the respective performance value above the threshold.

By the first node updating the first predictive model based on the respective explainability values of the first subset of respective second predictive models having the respective performance value above the threshold, the first node may enable to update the parameters of the first predictive model with loss computed on explainability values, e.g., SHAP values, and corresponding model predictions, that is, with explaining KPIs, of multiple local models, having optimal performance. The first node may thereby ensure that the first predictive model may learn from the explaining features of the respective second predictive models and consequently, to enable to obtain an improvement in the performance of the first predictive model, with fewer iterations of the updates of the parameters of the first predictive model. This may be understood to be by updating the first predictive model excluding the explainability of local models having degraded performance, such as that of the third node.

The loss function may also be enabled to rapidly converge in comparison with existing methods, which may be understood to alleviate the need to run further iterations. These benefits may be understood to in turn account for energy optimization, as computation time and cost may be lower, while performance may be improved.

By providing the indication to the third node, the first node may enable the third node to replace its degraded respective second model with the updated global model. This may enable to address the degradation of the respective second model of the third node, and thereby ensure that the first predictive model is enabled to predict the indicator of performance of the communications system with higher accuracy.

By providing the indication to the another node, the first node may enable the another node to execute the updated global model to predict the indicator of performance of the communications system for any use case, with the highest accuracy.

By receiving the first indication indicating the updated first predictive mode, the third node may be enabled to then replace its degraded respective second predictive mode of the indicator of performance of the communications system, with the updated first predictive model indicated by the received indication.

By replacing the respective second predictive model of the third node with the updated first predictive model, the third node may enable that only the performance degraded local model may be replaced, for improved generalization at the third node, that is, the local node.

The replacement action may be understood to be beneficial locally, when the local model performance may have degraded because of parameter updates due to interim undesirable training data, such as noise. The replacement may be understood to help to restore the “corrupted” model. Restoring local performance may be understood to also be advantageous for overall FL system stability.

By the second node sending the respective explainability values corresponding to the respective second predictive model having the respective performance value above the threshold to the first node, the second node enables the first node to then update the first predictive model with the respective explainability values.

### BRIEF DESCRIPTION OF THE DRAWINGS

Examples of embodiments herein are described in more detail with reference to the accompanying drawings, and according to the following description.

FIG. 1 is a schematic diagram illustrating two non-limiting embodiments, in panel a) and panel b) a communications system, according to embodiments herein.

FIG. 2 is a flowchart depicting a method in a first node, according to embodiments herein.

FIG. 3 is a flowchart depicting a method in a third node, according to embodiments herein.

FIG. 4 is a flowchart depicting a method in a second node, according to embodiments herein.

FIG. 5 is a schematic diagram illustrating a non-limiting example of an aspect of the method performed in the communications system, according to embodiments herein.

FIG. 6 is a schematic diagram illustrating another non-limiting example of some aspects of the method performed in the communications system, according to embodiments herein.

FIG. 7 is a schematic diagram illustrating yet another non-limiting example of the method performed in the communications system, according to embodiments herein.

FIG. 8 is a schematic diagram illustrating a further non-limiting example of some aspects of the method performed in the communications system, according to embodiments herein.

FIG. 9 is a schematic diagram illustrating an additional non-limiting example of some aspects of the method performed in the communications system, according to embodiments herein.

FIG. 10 is a schematic diagram illustrating some aspects of the method performed in the communications system, according to embodiments herein.

FIG. 11 is a schematic diagram illustrating some other aspects of the method performed in the communications system, according to embodiments herein.

FIG. 12 is a schematic diagram illustrating further aspects of the method performed in the communications system, according to embodiments herein.

FIG. 13 is a schematic block diagram illustrating two non-limiting examples, a) and b), of a first node, according to embodiments herein.

FIG. 14 is a schematic block diagram illustrating two non-limiting examples, a) and b), of a third node, according to embodiments herein.

FIG. 15 is a schematic block diagram illustrating two non-limiting examples, a) and b), of a second node, according to embodiments herein.

### DETAILED DESCRIPTION

Certain aspects of the present disclosure and their embodiments may provide solutions to the challenges discussed in the Background and Summary sections. There are, proposed herein, various embodiments which address one or more of the issues disclosed herein.

As a summarized overview, embodiments herein may be understood to relate to explainability driven model federation for scalable managed services for networks. Embodiments herein may leverage explainability of local models to define the loss computed while updating the global model in a FL setup, due to which the FL implementation may require fewer training iterations, converge faster, and perform better.

Given a stream of samples comprising of a set of features and a target KPI at multiple local node(s), along with the local model(s) used to compute the target KPI, the relative importance of the feature KPIs in determining the target may be determined by using explainability at each of the local node(s).

In one of the embodiments, this may be realized by examining the aggregated SHapley Additive exPlanations (SHAP) values [5] of the sample(s) [4]. Other explainability algorithms, such as Locally Interpretable Model-agnostic Explanations (LIME) [7], and DeepLIFT [8]) may be used in alternative embodiments.

The local model parameters, model performance and explainability values may be sent to a global node. The global model may initially be chosen as one of the local models having the best performance metric on the target KPI. It may be noted here that raw data, e.g., the feature KPIs, from the local node(s) may be understood not be shared with the global node. When the performance of a local model degrades, that is, when it may fall below a configured threshold, which may be suitably defined based on the target KPI, it may request the global node for an update. The global model parameters may be updated by computing the loss using the explainability values of the local model(s) where performance has not degraded. The local model with the degraded performance may then be replaced by the updated global model to improve performance at that node.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from Long Term Evolution (LTE)/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure. It may also be noted that the use-case involving MSN may be understood to be exemplary. Embodiments herein may be used for other applications involving FL as well.

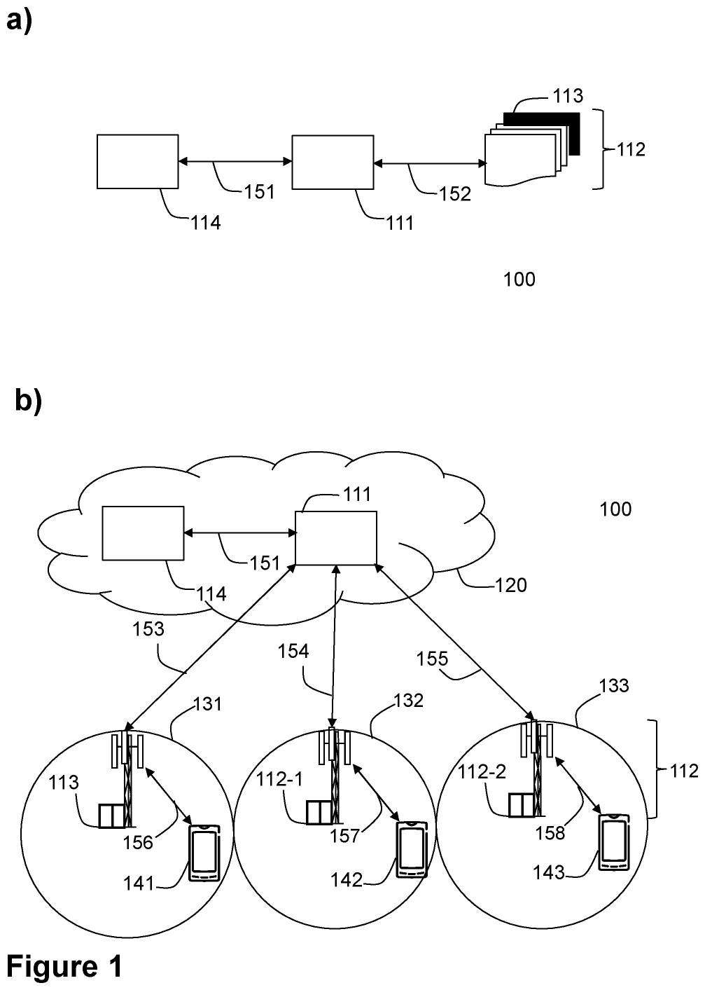

FIG. 1 depicts two non-limiting examples, in panels “a” and “b”, respectively, of a communications system 100, in which embodiments herein may be implemented. In some example implementations, such as that depicted in the non-limiting example of FIG. 1a, the communications system 100 may be a computer network. In other example implementations, such as that depicted in the non-limiting example of FIG. 1b, the communications system 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as a 5G system, e.g., 5G Core Network (CN), 5G New Radio (NR), an Internet of Things (IoT) network, an LTE network, e.g. LTE Frequency Division Duplex (FDD), LTE Time Division Duplex (TDD), LTE Half-Duplex Frequency Division Duplex (HD-FDD), LTE operating in an unlicensed band, or a newer system supporting similar functionality. The telecommunications system may also support other technologies, such as, e.g., Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 comprises a first node 111, which is depicted in FIG. 1. In some embodiments, the communications system 100 may further comprise a plurality of second nodes 112. The plurality of second nodes 112 may comprise a first subset of one or more second nodes 112, and a third node 113. In the non-limiting example of panel a) in FIG. 1, the plurality of second nodes 112 comprises the third node 113 and the first subset of the plurality of second nodes 112 comprising three second nodes 112. In the non-limiting example of panel b) in FIG. 1, the plurality of second nodes 112 comprises the third node 113 and the first subset of the plurality of second nodes 112 comprising two second nodes 112, indicated as a first second node 112-1 and a second second node 112-2. It may be understood that the first subset and/or the plurality of second nodes 112 may comprise additional nodes. The communications system 100 further comprises another 114 or fourth node 114, as also depicted in FIG. 1. It may be understood that the communications system 100 may comprise more nodes than those represented in FIG. 1. Any of the first node 111, the plurality of second nodes 112, the third node 113 and the another node 114 may be understood, respectively, as a first computer system, a second computer system, a third computer system and a fourth computer system. In some examples, any of the first node 111, the plurality of second nodes 112, the third node 113 and the another node 114 may be implemented as a standalone server in e.g., a host computer in the cloud 120, as depicted in the non-limiting example depicted in panel b) of FIG. 1 for the first node 111 and the another node 114. Any of the first node 111, the plurality of second nodes 112, the third node 113 and the another node 114 may, in some examples, be a distributed node or distributed server, with some of their respective functions being implemented locally, e.g., by a client manager, and some of their respective functions implemented in the cloud 120, by e.g., a server manager. Yet in other examples, any of the first node 111, the plurality of second nodes 112, the third node 113 and the another node 114, may also be implemented as processing resources in a server farm.

Any of the nodes in the of the nodes in the first subset of the plurality of second nodes 112 and the third node 113 may be separate nodes. In some embodiments, any of the first node 111, and the another node 114 may be independent and separated nodes from each other, or from any of the nodes in the first subset of the plurality of second nodes 112 and the third node 113. In other embodiments, any of the first node 111, and the another node 114 may co-localized or be the same node as any of the nodes in the first subset of the plurality of second nodes 112 and the third node 113. All the possible combinations are not depicted in FIG. 1 to simplify the Figure.

Any of the first node 111, the plurality of second nodes 112 and the third node 113 may be understood as to be a node having a capability to train one or more predictive models using ML. Particularly, the first node 111 may have a capability to train a global predictive model, whereas any of the plurality of second nodes 112 and the third node 113 may have a capability to train a respective local model. The first node 111 may be called a central or server node. The plurality of second nodes 112, e.g., the third node 113, may be called local nodes or client nodes to the central node. These local node(s) may be at cell-level, eNodeB or location area level, depending on the use-case.

Any of the first node 111, the plurality of second nodes 112, the third node 113 and the another node 114 may be a network node. In particular examples, any of the first node 111, and the another node 114 may be core network nodes. In some examples, the fourth node 114 may be a device, such as any of the devices 141, 142, 143 described below. Any of the plurality of second nodes 112, the third node 113 may be, respectively, a radio network node, as depicted in panel b) of FIG. 1. The radio network node may typically be a base station or Transmission Point (TP), or any other network unit capable to serve a wireless device or a machine type node in the communications system 100. The radio network node may be e.g., a 5G gNB, a 4G eNB, or a radio network node in an alternative 5G radio access technology, e.g., fixed or WiFi. The radio network node may be e.g., a Wide Area Base Station, Medium Range Base Station, Local Area Base Station and Home Base Station, based on transmission power and thereby also coverage size. The radio network node may be a stationary relay node or a mobile relay node. The radio network node may support one or several communication technologies, and its name may depend on the technology and terminology used. The radio network node may be directly connected to one or more networks and/or one or more core networks.

The communications system 100 may cover a geographical area, which in some embodiments may be divided into cell areas, wherein each cell area may be served by a radio network node, although, one radio network node may serve one or several cells. In the example of FIG. 1, the third node 113 serves a first cell 131, the first second node 112-1 serves a second cell 132, the second second node 112-2 serves a third cell 133. The network node may be of different classes, such as, e.g., macro eNodeB, home eNodeB or pico base station, based on transmission power and thereby also cell size. In some examples, the network node may serve receiving nodes with serving beams. The radio network node may support one or several communication technologies, and its name may depend on the technology and terminology used. Any of the radio network nodes that may be comprised in the communications system 100 may be directly connected to one or more core networks.

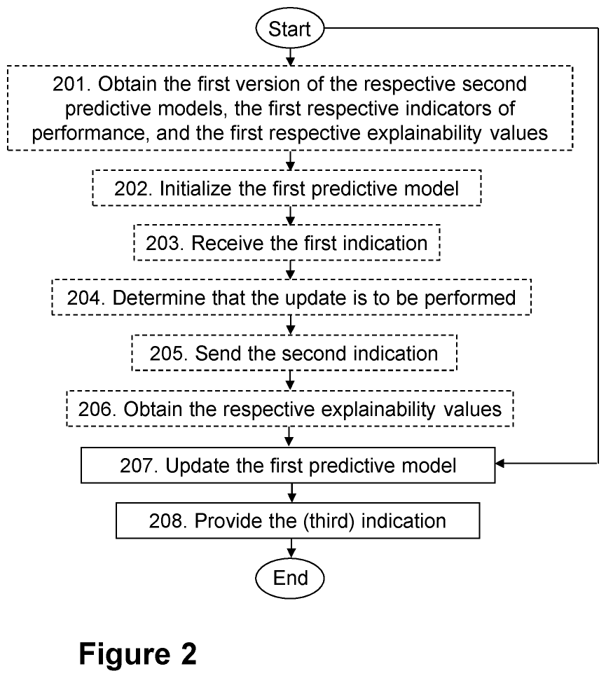

The communications system 100 may comprise a plurality of devices whereof a first device 141, a second device 142 and a third device 143 are depicted in panel b) of FIG. 1. In the non-limiting particular example of panel b) in FIG. 1, the first device 141 is served by the third node 113, the second device 142 is served by the first second node 112-1, and the third device 143 device is served by the second second node 112-2. It may be understood that each of the nodes in the plurality of second nodes 112 may respectively serve one or more devices. Only one device is depicted as being served by each of the plurality of devices 112 in panel b) of FIG. 2 to simplify the figure. Any of the devices comprised in the communications system 100 may be also known as e.g., user equipment (UE), a wireless device, mobile terminal, wireless terminal and/or mobile station, mobile telephone, cellular telephone, laptop with wireless capability, a Customer Premises Equipment (CPE), an Internet of Things (IoT) device, or a sensor, just to mention some further examples. Any of the devices comprised in the communications system 100 in the present context may be, for example, portable, pocket-storable, hand-held, computer-comprised, or a vehicle-mounted mobile device, enabled to communicate voice and/or data, via a RAN, with another entity, such as a server, a laptop, a sensor, an IoT device, a Personal Digital Assistant (PDA), or a tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. Any of the devices comprised in the communications system 100 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The first node 111 may communicate with the another node 114 over a first link 151, e.g., a radio link or a wired link. The first node 111 may communicate with the each of the nodes in the plurality of second nodes 112 over a respective second link 152, e.g., a radio link or a wired link. In the particular non-limiting example of panel b) in FIG. 1, the first node 111 may communicate with the third node 113 over a third link 153, e.g., a radio link or a wired link. the first node 111 may communicate with the first second node 112-1 over a fourth link 154, e.g., a radio link or a wired link. The first node 111 may communicate with the second second node 112-2 over a fifth link 155, e.g., a radio link or a wired link. The third node 113 may communicate with the first device 141 over a sixth link 156, e.g., a radio link or a wired link. The first second node 112-1 may communicate, directly or indirectly, with the second device 142 over a seventh link 157, e.g., a radio link or a wired link. The second second node 112-2 may communicate, directly or indirectly, with the third device 143 over an eighth link 158, e.g., a radio link or a wired link. Any of the first link 151, the respective second link 152, the third link 153, the fourth link 154, the fifth link 155, the sixth link 156, the seventh link 157 and/or the eighth link 158 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 1.

In general, the usage of “first”, “second”, “third”, “fourth”, “fifth”, “sixth”, “seventh” and/or “eighth” herein may be understood to be an arbitrary way to denote different elements or entities, and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

Embodiments of a computer-implemented method, performed by the first node 111, will now be described with reference to the flowchart depicted in FIG. 2. The method may be understood to be for handling predictive models. The first node 111 may be operating in the communications system 100.

The method may comprise the actions described below. In some embodiments some of the actions may be performed. In some embodiments, all the actions may be performed. In FIG. 2, optional actions are indicated with dashed boxes. One or more embodiments may be combined, where applicable. All possible combinations are not described to simplify the description. It should be noted that the examples herein are not mutually exclusive.

Components from one example may be tacitly assumed to be present in another example and it will be obvious to a person skilled in the art how those components may be used in the other examples.

### Action 201

In the course of operations in the communications system 100, it may be of interest to predict an indicator of performance of the communications system 100, e.g., y, such as a Key Performance Indicator (KPI). The indicator of performance of the communication system 100 y may be understood to be a target indicator of performance. For the purpose of predicting the indicator of performance y, the first node 111 may generate and train a first predictive model, M_{G}, of the indicator of performance y of the communications system 100. The first node 111, which may be understood as a central or global node, may ultimately generate the first predictive model, M_{G}, e.g., with FL, in a co-operative fashion with the plurality of second nodes 112. The plurality of second nodes 112, Cⁱ, may be understood to comprise N local or client nodes. Each of the second nodes 112 may generate a respective second predictive model, e.g., M_{C}ⁱ, which may be also referred to as a respective local model. Each respective second predictive model, M_{C}ⁱ, may be trained to, and subsequently, predict the target indicator y of performance of the communications system 100, e.g., target KPI, computed from feature indicators of performance, e.g., feature KPIs such as Uplink Received Signal Strength Indicator (RSSI), Physical Resource Block (PRB) Utilization (kpi_prb_util_calc), LTE downlink transmission time interval (kpilte_se_dl_tti), etc. The feature indicators of performance may be generated, for example, by suitable KPI creation processes from Performance Management (PM) counter data. The plurality of second nodes 112, Cⁱ, may communicate with the first node 111 by sharing model parameters M_{C}ⁱ, e.g., neural network weights.

Embodiments herein may be understood to advantageously comprise computation, by each of the nodes in the plurality of second nodes 112, Cⁱ, of explainability values, S_{C}ⁱ, which the plurality of second nodes 112, Cⁱ, may have respectively computed for the respective second predictive models using, for example, a SHAP explainer. These explainability values, S_{C}ⁱ, may then also be shared with the first node 111.

In this Action 201, the first node 111 may obtain, from each of the second nodes in the plurality of second nodes 112, Cⁱ, as obtained after a first number of iterations of training the respective second predictive models, respectively, by the plurality of second nodes 112: i) first respective parameters, e.g., M_{C}ⁱ, of a first version of the respective second predictive models, ii) first respective indicators of performance, e.g., P_{C}ⁱ, of the first version of the respective second predictive models, and iii) first respective explainability values, e.g., S_{C}ⁱ, of the first version of the respective second predictive models.

Each iteration of a predictive model may result in a version of the respective model. That is, in a set of weights for each of the feature indicators, e.g., feature KPIs, in the respective model. The respective model may be considered to be trained when a certain performance value may be obtained, e.g., an accuracy may be obtained, that may exceed a certain performance threshold. The performance may be measured with a performance metric, such as percentage improvement in Root Mean Squared Error (RMSE), number of iterations required and or convergence of the model loss function. Each may be understood to have a respective threshold. The first version of the respective second predictive model may refer to that obtained after a certain number, or first number, of iterations of training, not necessarily a single iteration.

Obtaining may be understood as receiving, or retrieving, e.g., via the respective second link 152.

Each of the predictive models, any of the respective second predictive models and the first predictive model, may be understood to be an ML model, such as a multi-layer perceptron models for regression.

By obtaining the first respective parameters, e.g., M_{C}ⁱ, of the first version of the respective second predictive models, ii) the first respective indicators of performance, e.g., P_{C}ⁱ, of the first version of the respective second predictive models, and iii) the first respective explainability values, e.g., S_{C}ⁱ, of the first version of the respective second predictive models in this Action 201, the first node 111 may be enabled to pick, in the next Action 202, the best performing local model to initialize the first predictive model, that is, the general or global model M_{G}, which may enable it to ultimately predict the indicator of performance of the communications system 100, e.g., the target KPI.

### Action 202

In this Action 202, the first node 111 may initialize the first predictive model, e.g., M_{G}, that is, the central or global model, with the first version of one of the respective second predictive models. The first version of the one of the respective second predictive models may correspond to the best performing model of the first version of the respective second predictive models after the first number of iterations of training of the first version of the respective second predictive models. That is, the first node 111 may choose, out of all the second predictive models obtained in Action 201, the respective second predictive model having the highest first respective indicator of performance to initialize the first predictive model with, in other words, the best performing local model.

Initializing may be understood as setting the parameters of the first predictive model, that is, the global model as the parameters of the selected respective second predictive model, e.g., the local mode.

By initializing the first predictive model with the first version of the one of the respective second predictive models in this Action 202, the first node 111 may be enabled to build a global model that may best predict the indicator of performance of the communications system 100, e.g., the target KPI, from among the local models available for predicting the indicator of performance of the communications system 100, e.g., the target KPI, compared to randomly selecting a local model, the advantage may be understood to be that the current global model may be the best representative model for that indicator of performance of the communications system 100, e.g., that KPI, in the FL system.

### Action 203

Each of the nodes in the plurality of second nodes 112 may continue to collect data on the feature indicators used to predict the target indicator of the performance of the communications system 100, and thereby continue to train the respective second predictive model with the newly collected data. Each of the nodes in the plurality of second nodes 112 may continue to monitor the respective performance of the respective second predictive model during the training. At some point, at least one of the nodes in the plurality of second nodes 112, referred to herein as the third node 113, may detect a degradation in the performance of its respective second predictive model. The degradation in the performance of the respective second predictive model of the third node 113 may be due, for example, to local factors, such as drift or noise in training data, e.g., feature KPIs, or abrupt changes in usage patterns due to physical or environmental factors, malicious users, or devices, among others. The degradation may usually be measured as an increase in the error on the model predictions.

In this Action 203, the first node 111 may receive a first indication from the third node 113. The first indication may request an update of a second version of the respective second predictive model of the third node 113.

To update may be understood as to replace model parameters, e.g., to replace weights of one or more features.

The requested update may be due to the detected degradation of the second version of the respective second predictive model of the third node 113, e.g., after an additional number of iterations of training of the respective second predictive model trained by the third node 113.

The first indication may indicate, for example, a degradation, e.g., an increase in error, on the prediction of a target KPI such as downlink or uplink throughput, latency, number of users, block error rate, physical resource block utilization, etc. by the respective second predictive model, e.g., in the context of MSN use-case.

By receiving the first indication in this Action 203, the first node 111 may be enabled to know that that it may need to send a new version of the predictive model to the third node 113, so the third node 113 may replace its degraded version of its respective predictive model with one with better performance. Furthermore, the first node 111 may be enabled to then update the first predictive model excluding the explainability of local models having degraded performance.

### Action 204

In this Action 204, the first node 111 may determine that the update to the first predictive model, e.g., M_{G}, is to be performed, based on a detected degradation of the second version of one of the respective second predictive models. That is, the second version of the respective second predictive model of the third node 113.

Determining may be understood as calculating, deriving, or similar.

In some embodiments, the determining in this Action 204 may be based on the received first indication from the third node 113 in Action 203. In other examples, the determining in this Action 204 may be performed by the first node 111 detecting the degradation itself, e.g., based on a periodic report of a second respective indicator of performance of the second version of the respective second predictive model from the third node 113.

By determining that the update to the first predictive model is to be performed in this Action 204, the first node 111 may be enabled to drive the (re)-training of the first predictive model, that is, the global model, based on performance degradations at local nodes such as the third node 113. This may in turn ensure that the model parameters of the first predictive model may be then updated using the respective second predictive models of second nodes 112 which may be performing well on predicting the indicator of performance of the communications system 100, e.g., the target KPI, excluding the respective second predictive models of nodes whose performance may be degraded. This may be understood to ultimately lead to faster convergence of the first predictive model, with fewer iterations, as will be described later.

### Action 205

While the degradation may have been detected in the respective second predictive model trained by the third node 113, other respective second predictive models trained, respectively, by other second nodes in the plurality of second nodes 112 may not have degraded. Particularly, a first subset, S_{C}^{j}, of the plurality of second nodes 112 may have determined a first subset, k, of respective second predictive models of the indicator of performance of the communications system 100, having a respective performance value above the threshold.

In this Action 205, the first node 111 may send, to the second nodes in the first subset, C^{j}, of the plurality of second nodes 112, a second indication. The second indication may request to provide respective explainability values, e.g., S_{C}^{j}, as obtained after a second number of iterations of training the first subset, k, of the respective second predictive models, respectively, by the first subset, C^{j}, of the plurality of second nodes 112. That is, each of the second nodes in the first subset, C^{j} of the plurality of second nodes 112, may train a respective second predictive model having a respective performance value above the threshold.

The sending, e.g., transmitting, may be performed by the respective second link 152.

The second indication may be, for example, a command or a trigger.

The explainability values S_{C}^{j} may have been respectively computed by each of the j second nodes in the first subset, C^{j}, of the plurality of second nodes 112 for the feature indicators, e.g., feature KPIs, using model predictions y on the feature indicators, e.g., KPIs, using a suitable algorithm, such as SHAP explainer.

By sending the second indication in this Action 205, the first node 111 may then be enabled to obtain explainability values from the local models to update the parameters of the first predictive model, that is, the global model. As explained earlier, this may in turn ensure that the model parameters of the first predictive model may be then updated using the respective second predictive models of second nodes 112 which may be performing well on predicting the indicator of performance of the communications system 100, e.g., the target KPI, excluding the respective second predictive models of nodes whose performance may be degraded. This may be understood to ultimately lead to faster convergence of the first predictive model, with fewer iterations, as will be described later.

### Action 206

In this Action 206, the first node 111 may obtain, from each of the second nodes in the first subset, C^{j}, of the plurality of second nodes 112, respective explainability values, e.g., S_{C}^{j}, as obtained after a second number of iterations of training the first subset, k, of the respective second predictive models, respectively, by the first subset, C^{j}, of the plurality of second nodes 112.

The obtaining, e.g., receiving, may be performed by the respective second link 152.

The respective explainability values, e.g., S_{C}ⁱ, may be obtained in this Action 206 in response to the sent second indication in Action 205.

It may be noted that while the respectively explainability values are obtained from the second nodes in the first subset, C^{j} of the plurality of second nodes 112, the feature indicators, e.g., KPIs, generated are kept private, that is, not shared with the first node 111.

By the first obtaining the respective explainability values S_{C}ⁱ, from each of the second nodes in the first subset, C^{j} of the plurality of second nodes 112, the first node 111 may be enabled to, at that instant, to learn from representative attributes, captured by explainability, of local models that may be understood to be performing well in predicting the indicator of performance y, e.g., the target KPI. The global model parameters may be influenced by these representative attributes, as opposed to by factors such as relative number of samples at the local nodes in conventional FedAvg, allowing the first node 111 to dynamically adapt to the performance of the local nodes. The use of explainability values may be understood to additionally result in energy efficiency, since it may be understood that the use of these values may result in faster convergence of the loss function in fewer iterations, as these may have been determined from local models that may be understood to have been performing well on predicting the indicator of performance, e.g., the target KPI. Thus, multiple benefits may be realized in the FL setup.

### Action 207

In this Action 207, the first node 111 updates, using ML, the first predictive model, M_{G}, of the indicator of performance of the communications system 100. The updating in this Action 206 is based on the respective explainability values S_{C}^{j}, respectively obtained from the first subset C^{j} of the plurality of second nodes 112 operating in the communications network 100. The respective explainability values S_{C}^{j} correspond to the first subset, k, of respective second predictive models of the indicator of performance of the communications system 100, respectively determined by the first subset, C^{j}, of the plurality of second nodes 112. The models in the first subset, k, of the respective second predictive models have the respective performance value above the threshold.

Updating the first predictive model may comprise updating the parameters of the first predictive model, that is, the global model parameters. The updating of the parameters of the first predictive model may be performed using a loss function.

Machine learning in this Action 207 may be, e.g., FL. Non-limiting examples of algorithms that may be used to perform the ML, e.g., FL, in this Action 207 may be, e.g., Federated Averaging, Federated Stochastic Gradient Descent, Federated Learning with Dynamic Regularization, among others.

The updating in this Action 207 may be performed using a loss function, F, computed using the respective explainability values S_{C}^{j}, that is, the explainability values respectively obtained from the first subset C^{j}, of the plurality of second nodes 112. In other words, the respective explainability values of local models having good performance. The explainability values may have been computed on local model(s) predictions of target KPI(s) using feature KPIs.

Expressed differently, the loss function, F, may be computed using explainability values of all local nodes that may not have degraded performance (k≠i), or:

$${w}_{( t + 1 )} ← {w}_{t} - η {\sum }_{{k = 1}_{k \neq i}}^{K} {\sum }_{j = 1}^{{n}_{k}} ∇ {F}_{k} ( {S}_{C}^{{k}_{j}} , {y}_{{S}_{C}}^{{k}_{j}} ; {M}_{C}^{{k}_{j}} ( w ) )$$

In other words, in this Action 207, the first node 111 may update parameters of the first predictive model, M_{G}, using explainability, e.g., SHAP, values S_{C}^{j}, of other nodes C^{j} having good performance. This may be done only for one epoch for each node C^{j}, that is by a partial_fit. Updating over one epoch may be understood to mean updating the first predictive model parameters with one iteration over each of the set of explainability values from the local nodes successively, rather than performing multiple iterations, epochs, with each set. This may be understood to allow the global model to be updated partially by explainability values of each of the local nodes. That is, the global model may be partially updated by the explaining features of each local model.

In some embodiments, the updating in this Action 207 may comprise refraining from updating the first predictive model, e.g., M_{G}, with respective explainability values corresponding to a second subset of respective second predictive models of the indicator of performance of the communications system 100, respectively determined by a second subset of the plurality of second nodes 112. The models in the second subset of respective second predictive models may have the respective performance value below the threshold.

The updating in this Action 207 may be performed based on a result of the determination in Action 204 that the update is to be performed.

It may be understood that Action 201 may be performed prior to the updating 207 of the first predictive model, e.g., M_{G}.

Since explainability may be understood to capture the important attributes that may determine the model predictions on the indicator of performance that may be desired to be predicted, e.g., the target KPI, updating the model loss using these values may be expected to drive model weights to optimality faster, than determining the local contribution based on a ratio of number of contributing data samples, as in existing methods.

By the first node 111 updating the first predictive model, M_{G}, of the indicator of performance of the communications system 100 based on the respective explainability values S_{C}^{j} respectively obtained from the first subset C^{j} of the plurality of second nodes 112, the first node 111 may enable to update the parameters of the first predictive model, that is, the global model parameters, with loss computed on explainability, e.g., SHAP, values and corresponding model predictions, that is, with explaining KPIs, of multiple local models having optimal performance. The first node 111 may thereby ensure that the first predictive model may learn from the explaining features and consequently, may enable to obtain an improvement in the performance of the first predictive model, with fewer iterations of the global model parameter updates. This may be understood to be by updating the first predictive model excluding explainability of local models having degraded performance, such as that of the third node 113.

The loss function may also be enabled to rapidly converge in comparison with existing methods, which may be understood to alleviate the need to run further iterations. These benefits may be understood to in turn account for energy optimization, as computation time and cost may be lower, while performance may be improved.

### Action 208

In this Action 208, the first node 111 provides an indication of the updated first predictive model, \hat{M}_{G}, to the third node 113 comprised in the plurality of second nodes 112 and excluded from the first subset, that is, the i^{th} node that may have reported degradation in performance, or to another node 114 operating in the communications system 100.

The provided indication may be understood to be a third indication.

Providing may be understood as e.g., sending or transmitting, e.g., via the third link 153 to the third node 113, or via the first link 151 to the another node 114.

The indication, that is, the third indication may be, for example, a command or trigger.

By providing the indication to the third node 113, the first node 111 may enable the third node 113 to replace its degraded respective second model M_{C}ⁱ with the updated global model \hat{M}_{G}, using the updated parameters w₍ₜ₊₁₎. This may enable to address the degradation of the respective second model of the third node 113, and thereby ensure that the first predictive model is enabled to predict the indicator of performance of the communications system 100 y with higher accuracy.

By providing the indication to the another node 114, the first node 111 may enable the another node 114 to execute the updated global model \hat{M}_{G}, using the updated parameters w₍ₜ₊₁₎ to predict the indicator of performance of the communications system 100 y for any use case, with the higher accuracy.

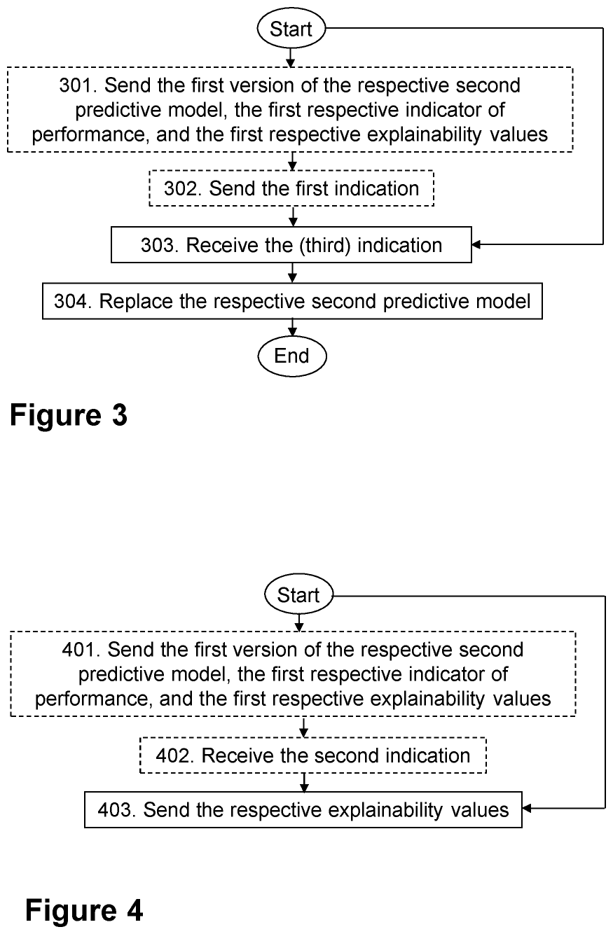

Embodiments of a computer-implemented method, performed by the third node 113, will now be described with reference to the flowchart depicted in FIG. 3. The method may be understood to be for handling predictive models. The third node 113 may be operating in the communications system 100.

The method may comprise the following actions. Several embodiments are comprised herein. In some embodiments, the method may comprise all actions. In other embodiments, the method may comprise some of the actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 3, optional actions are depicted with dashed lines.

A non-limiting example of the method performed by the third node 113 is depicted in FIG. 3. In FIG. 3, optional actions in some embodiments may be represented with dashed lines. The detailed description of some of the following corresponds to the same references provided above, in relation to the actions described for the first node 111 and will thus not be repeated here to simplify the description. For example, the explainability values may be computed using a SHAP explainer.

### Action 301

In this Action 301, the third node 113 may send, to the first node 111, as obtained after the first number of iterations of training the respective second predictive model: i) the first respective parameters of the first version of the respective second predictive model, ii) the first respective indicator of performance of the first version of the respective second predictive model, and iii) the first respective explainability values of the first version of the respective second predictive model.

### Action 302

When the performance of the local model of the third node 113, that is, of its respective second predictive model, may degrade, the third node 113 may request for model update from central node, that is, from the first node 111.

In this Action 302, the third node 113 may send the first indication to the first node 111. As explained earlier, the first indication may request the update of the second version of the respective second predictive model of the third node 113. The requested update may be due to the detected degradation of the second version of the respective second predictive model of the third node 113.

### Action 303

In this Action 303, the third node 113 receives the indication from the first node 111 operating in the communications system 100. The indication indicates the updated first predictive model of the indicator of performance of the communications system 100. The updated first predictive model is based on the respective explainability values respectively obtained from the first subset of the plurality of second nodes 112 operating in the communications network 100. The respective explainability values correspond to the first subset of respective second predictive models of the indicator of performance of the communications system 100, respectively determined by the first subset of the plurality of second nodes 112. As explained earlier, the models in the first subset of the respective second predictive models have the respective performance value above the threshold. The respective second predictive model of the indicator of performance of the communications system 100 of the third node 113 has the respective performance value below the threshold. The third node 113 is comprised in the plurality of second nodes 112 but excluded from the first subset of the plurality of second nodes 112.

The received indication may be understood to be the third indication.

As also explained earlier, the first predictive model may be understood to be a global model, and the respective second predictive models may be understood to be local models.

Action 301 may be understood to be performed prior to the receiving of the third indication in this Action 303.

The receiving in this Action 303 of the indication may be based on the sent first indication in Action 302.

### Action 304

In this Action 304, the third node 113 replaces the respective second predictive model of the indicator of performance of the communications system 100 of the third node 113 with the updated first predictive model indicated \hat{M}_{G} by the received indication.

By performing this Action 304, the third node 113 may enable that only the performance degraded local model may be replaced, for improved generalization at the third node 113, that is, the local node.

Embodiments of a computer-implemented method, performed by the second node 112, will now be described with reference to the flowchart depicted in FIG. 4. The method may be understood to be for handling predictive models. The second node 112 may be operating in the communications system 100.

The method may comprise the following actions. Several embodiments are comprised herein. In some embodiments, the method may comprise all actions. In other embodiments, the method may comprise one or more of the actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are depicted with dashed lines.

A non-limiting example of the method performed by the second node 112 is depicted in FIG. 4. In FIG. 4, optional actions in some embodiments may be represented with dashed lines. The detailed description of some of the following corresponds to the same references provided above, in relation to the actions described for the first node 111 and will thus not be repeated here to simplify the description. For example, the explainability values may be computed using a SHAP explainer.

It may be understood that the method described herein in relation to FIG. 4 may be performed by any of the second nodes 112 comprised in the first subset of the plurality of second nodes 112. That is, any second node 112 having determined a respective second predictive model having a respective performance value above the threshold. It may be understood that the identity of the third node 113 and the second nodes comprised in the first subset of the plurality of second nodes 112 may vary along time, e.g., from iteration to iteration, and it may be understood to depend on which second node 112 may experience a degradation in the performance of its respective second predictive model.

### Action 401

In this Action 401, the second node 112 may send, to the first node 111, as obtained after the first number of iterations of training the respective second predictive model: i) the first respective parameters of the first version of the respective second predictive model, ii) the first respective indicator of performance of the first version of the respective second predictive model, and iii) the first respective explainability values of the first version of the respective second predictive model.

The respective second predictive model may be understood to be a local model.

### Action 402

In this Action 402, the second node 112 may receive, from the first node 111, the second indication requesting to provide the respective explainability values as obtained after the second number of iterations of training the respective second predictive model.

### Action 403

In this Action 403, the second node 112 sends, to the first node 111 operating in the communications system 100, the respective explainability values corresponding to the respective second predictive model of the indicator of the performance of the communications system 100. The respective second predictive model has been determined by the second node 112. The respective second predictive model has a respective performance value above the threshold.

The respective explainability values may be sent in response to the received second indication. The respective explainability values may be obtained after the second number of iterations of training of the respective second predictive model.

Without loss of generality, embodiments herein, e.g., in relation to FIGS. 2-4, may be understood to describe a single global model with multiple local model(s). However, multiple global model(s) may exist when multiple target KPIs may need to be predicted, and each may be derived from respective local model(s) that may predict the same KPI.

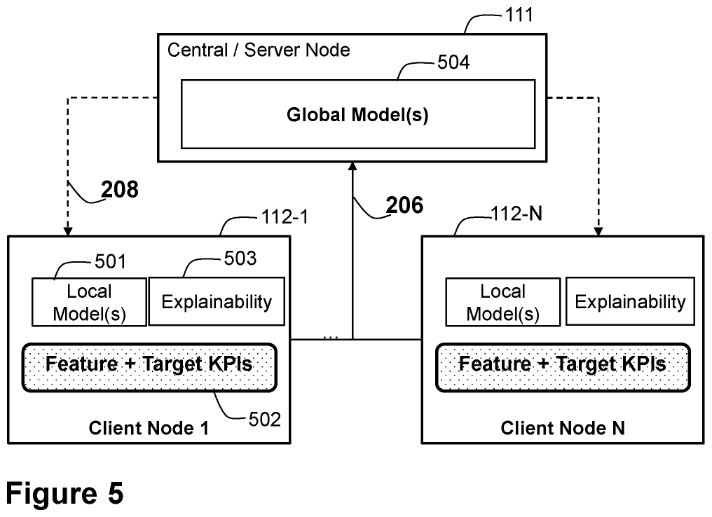

FIG. 5 is a schematic diagram illustrating an overview of the approach followed by embodiments herein for explainability driven model federation for network management. In particular, FIG. 5 depicts a summary workflow of the approach followed by embodiments herein in a FL setup involving up to N second nodes 112, that is, client nodes, hosting the respective second predictive models 501. That is, the local model(s) trained to predict the indicator of performance of the communications system 100, a target KPI(s), using feature KPIs 502. These local node(s) may be at cell-level, eNodeB or location area level, depending on the use-case. The explainability 503 of the local model(s) may be used to update the first predictive model 504, that is, the global model, for that KPI when the performance of local model(s) at the client node(s) may degrade. The data which is not shared between the first node 111, e.g., the server, and client node(s) is indicated in the dotted boxes, e.g., KPI data in a degradation prediction use-case for MSN. The solid lines and arrows represent workflows from the client nodes to the central node, e.g., sharing of local model parameters or explainability values according to Action 206, while dotted arrows represent the workflow from the central node to the client nodes, e.g., updating local model(s) with the global model, e.g., according to Action 208.

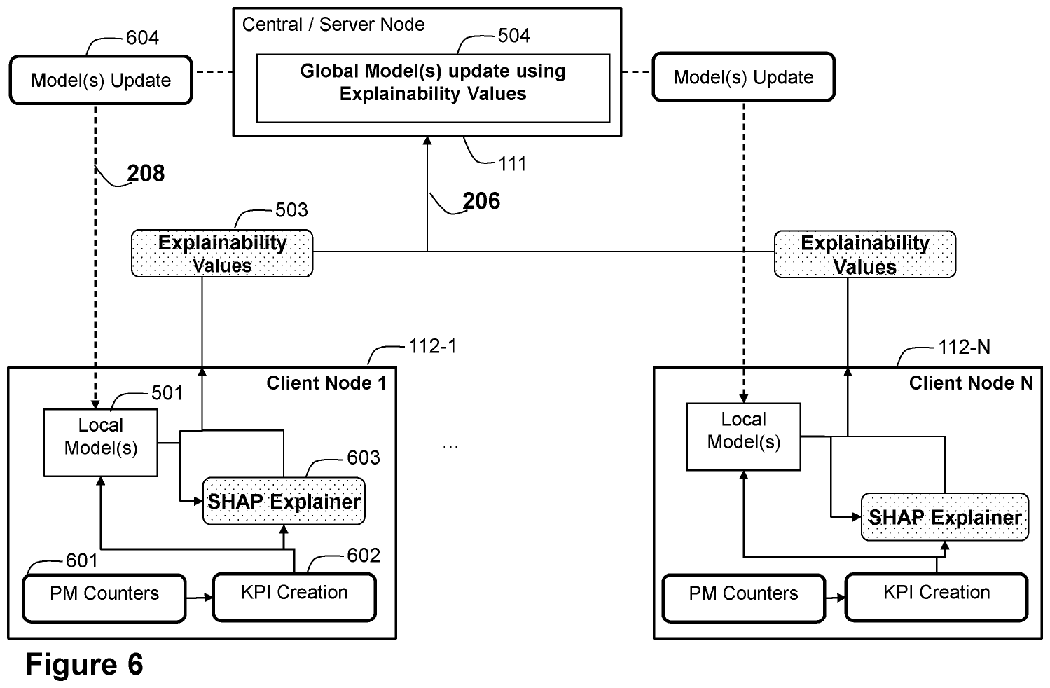

FIG. 6 is a schematic diagram illustrating a detailed diagram of the approach followed by embodiments herein. As depicted in FIG. 6, N second nodes 112, that is, N local or client nodes, comprise the respective second predictive models 501. That is, local model(s) which may be trained to, and subsequently, predict the target KPI computed from feature KPIs. These may be generated by suitable KPI creation processes 601 from PM counter data 602. These nodes may communicate with the first node 111, that is, the global node which may also be called the central or server node, by sharing model parameters. The approach followed by embodiments herein may be understood to involve computation of explainability values 503, as indicated in the dotted boxes, using, for instance, a SHAP explainer 603. These explainability values may also be shared with the central node for updating the global model 504 parameters. The model updates 604 may then be shared when the performance of any of the second nodes 112 may degrade below a threshold. The solid lines and arrows represent workflows from the client nodes to the central node, e.g., according to Action 206, while dotted arrows represent the workflow from the central node to the client nodes, e.g., according to Action 208.

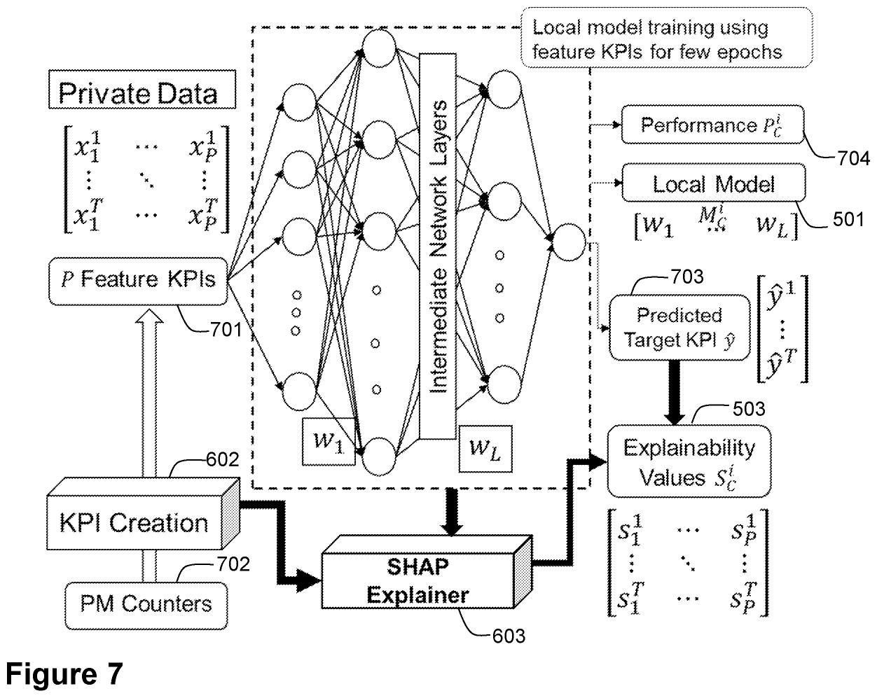

FIG. 7 is a schematic diagram illustrating a non-limiting example of the components a local node may comprise in embodiments herein to train a model, that is a respective second predictive model 501, to predict the indicator of performance of the communications system 100. That is, a target KPI 602, from the feature KPIs 701. Also illustrated is the computation of explainability values 503. The following describes the corresponding workflow. At the i^{th} local client node Cⁱ, the local model M_{C} may be updated using few epochs of gradient descent on P feature KPIs 701 generated from PM data 702 for T ROPs, not until convergence. The explainability values S_{C}ⁱ 503 may be computed for the feature KPIs 701 using model predictions y 703 on the feature KPIs, using a suitable algorithm, such as SHAP explainer 603. The local model performance P_{C}ⁱ 704 may be computed and used to trigger model sharing to the first node 111, that is, the central node, or update of the local model 501 after updating the global model according to Action 207 of embodiments herein. The outputs at the local client node, which may be shared according to Action 403 and Action 206, may include: the explainability Values S_{C}ⁱ 503, the performance of model P_{C}ⁱ 704, and the local Model parameters M_{C} 501, e.g., neural network weights. It may be noted here that KPIs 701 generated may be private, that is, not shared.

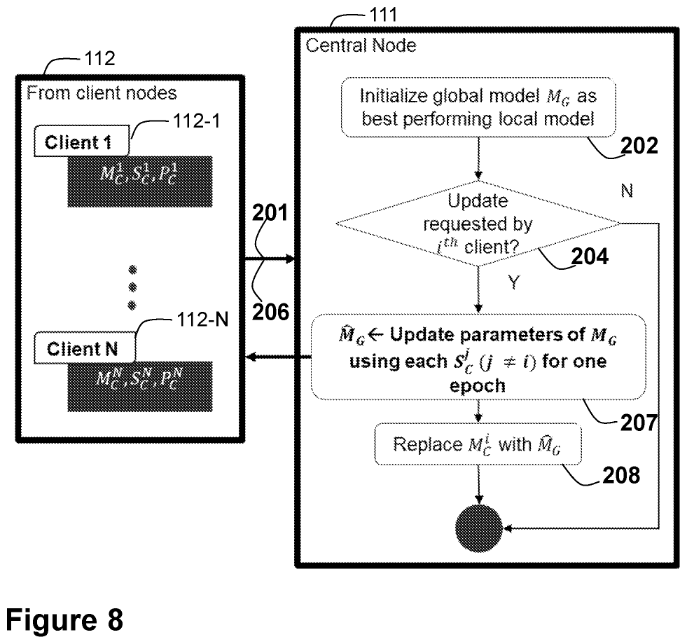

FIG. 8 is another schematic diagram illustrating a non-limiting example of embodiments herein, wherein the FL may be implemented. FIG. 4 depicts the workflow at the first node 111, that is, the central/server/global node. According to Action 201, the first node 111 may receive from the plurality of second nodes 112, that is, of the N clients: the first respective parameters of a first version of the respective second predictive models, M_{C}¹ . . . M_{C}^{N}, one for each node, the first respective explainability values of the first version of the respective second predictive models S_{C}¹ . . . S_{C}^{N}, one for each node, and first respective indicators of performance of the first version of the respective second predictive models P_{C}¹ . . . P_{C}^{N}, one for each node. Then, the first node 111 may, in accordance with Action 202, initialize the first predictive model, that is, the global model M_{G} using the best performing local model. When a local model performance degrades, e.g., that of the third node 113, depicted in FIG. 8 as the l^{th} client, the third node 113 may, in accordance with Action 302 and Action 203, request a model update from the first node 111. In response to receiving the first indication, the first node 111 may determine, in accordance with Action 204 that it may need to update the first predictive model, that is, the global model M_{G}. The first node 111 may then, according to Action 206 obtain the explainability values from the first subset of the plurality of second nodes 112. According to Action 207, the first node 111 may then, update the first predictive model, that is, the global model M_{G}, using the loss function computed on the respective explainability values obtained from the first subset of the plurality of second nodes 112, that is, of the local models having good performance. Particularly, the first node 111 may update the parameters of M_{G} using the explainability SHAP values of other nodes S_{C}^{j} having good performance. This may be done only for one epoch for each node C^{j}, partial_fit. The third node 113, that is, the l^{th} client, is comprised in the plurality of second nodes 112 but excluded from the first subset. Hence j≠i. The first node 111 may then, according to Action 208, provide the indication of the updated global model \hat{M}_{G} to the third node 113 and indicate to it that the updated model is to replace the degraded local model M_{C}ⁱ.

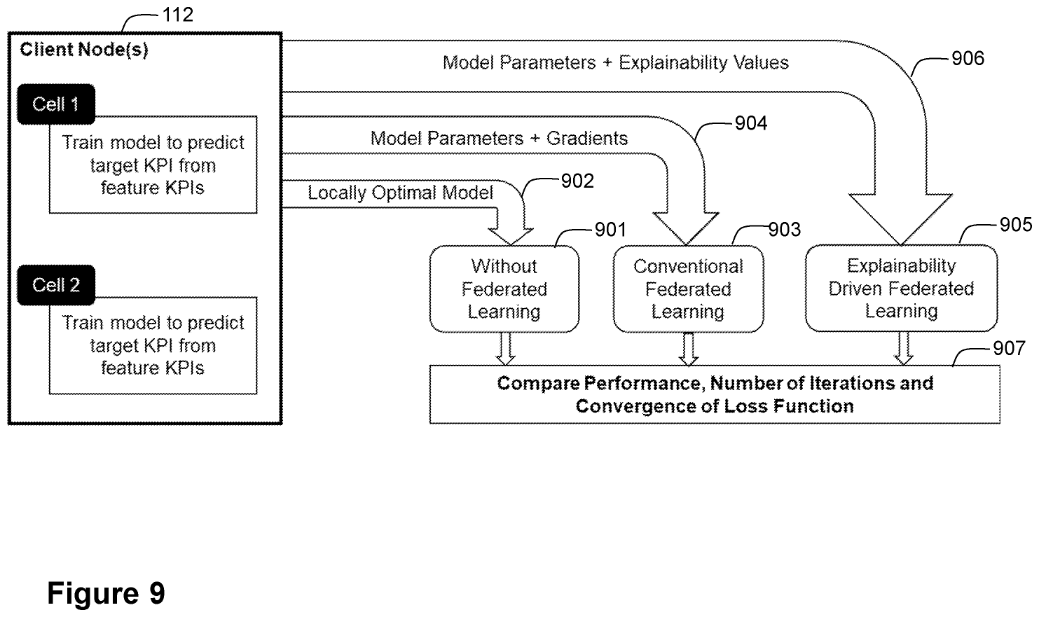

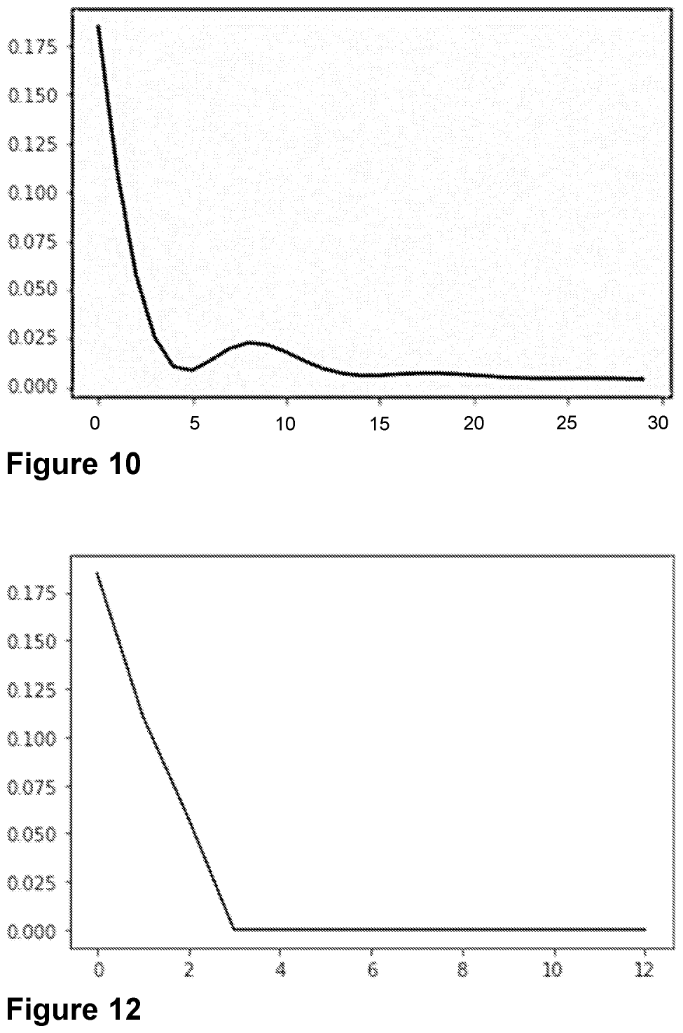

FIG. 9 is another schematic diagram illustrating an experiment conducted to analyze the validity of the approach followed by embodiments herein with two different cells, Cell 1 and Cell 2 as second nodes 112. PM counter data were collected for a duration of 1 month, at 15 minute ROP. The raw counter data was processed to obtain a set of 23 KPIs which were used as features, and multi-layer perceptron models for regression were used to predict a target KPI, which in the experiment conducted was the user downlink throughput (kpi_dlthroughputuser). Data of a specific frequency band, 800 MHz, was selected for analysis, of which 80% was used for training and 20% was used for testing. The performance for three cases was evaluated and compared. The first case 901 may be understood as the baseline case, without federated learning, where the local models 902 were trained until convergence and used to predict the target KPI on the test set. The second case 903 was that performed with conventional federated learning, where basic FedAvg was implemented using the local models and their gradients 904. The third case 905 was conducted according to embodiments herein, where the evaluation was done after the global model had been updated using the local models along with the explainability values 906. The performance was compared at 907 on account of a performance metric, such as percentage improvement in Root Mean Squared Error (RMSE), number of iterations required and convergence of the model loss function. The following FIGS. 10-12 and Tables show the results of the experiment.

FIG. 10 is a graphic representation of the number of iterations, in the horizontal axis, required for convergence, in the vertical axis, of the local model loss function and Table 1 compares the performance of the baseline approach without federated learning. It may be observed that the convergence of the loss function required more iterations, and improvements of 39.58% and 53.98% were obtained for the respective cells using models trained for 15 iterations when compared with the performance obtained using models trained for 3 iterations.

TABLE 1

| | Iterations = 3 | | Iterations = 15 | |
|---|---|---|---|---|
| Local Model | Loss | RMSE | RMSE | % RMSE Improvement |
| Cell 1 | 0.0579 | 0.0609 | 0.0368 | 39.58 |
| Cell 2 | 0.0662 | 0.0836 | 0.0385 | 53.98 |

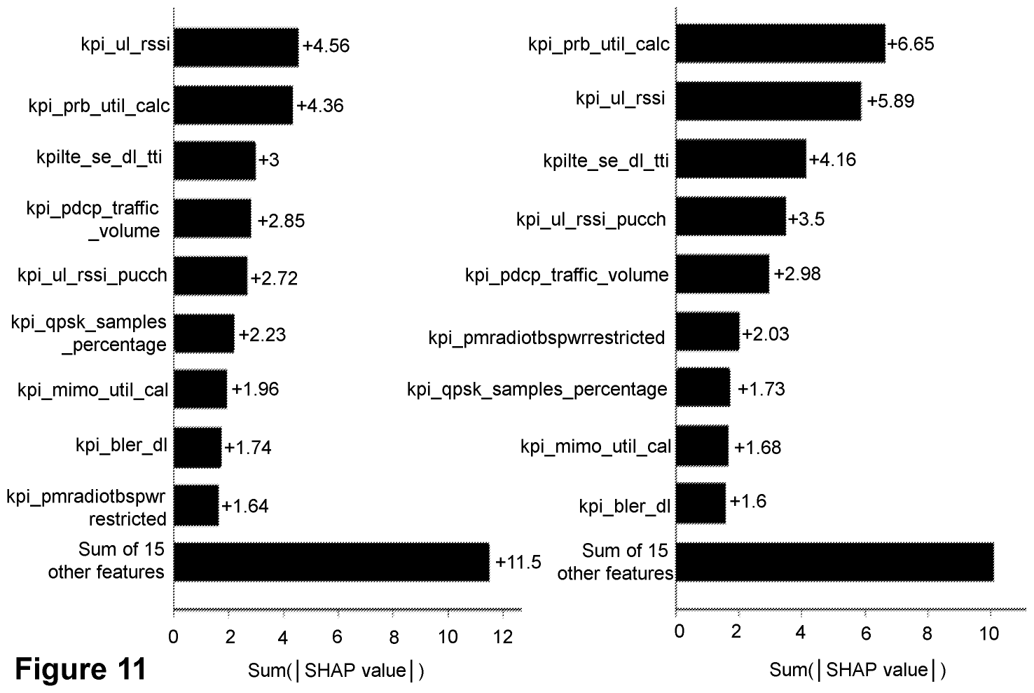

FIG. 11 depicts the cohort plots of the SHAP values, indicative of explainability values, of the feature KPIs in predicting the target KPI for the respective cells in FIG. 9 and FIG. 10. The cohort plots of the SHAP values for Cell 1 are depicted on the graph on the left side of FIG. 11, while the cohort plots of the SHAP values for Cell 2 are depicted on the graph on the right side of FIG. 11. The SHAP values may be understood to be indicative of the primary contributing features, such as Uplink Received Signal Strength Indicator (kpi_ul_RSSI), Physical Resource Block (PRB) Utilization (kpi_prb_util_calc), an LTE downlink transmission time interval (kpilte_se_dl_tti). Other features depicted on FIG. 11 are: Packet Data Convergence Protocol traffic volume (kpi_pdcp_traffic_volume), Uplink Received Signal Strength Indicator (RSSI) Physical Uplink Control Channel (PUCCH) (kpi_ul_rssi_pucch), Quadrature Phase Shift Keying samples percentage (kpi_qpsk_samples_percentage), Multiple-Input Multiple-Output utilization (kpi_mimo_util_cal), downlink Block Error Rate (kpi_bler_dl), and the count of the number of Transport Blocks on MAC level scheduled in uplink where the UE was considered to be power limited (kpi_pmradiotbspwrrestricted), as well as the sum of 15 other features.

Further, the performance using conventional FL, with FedAvg, and the approach followed by the embodiments herein was compared in the Table 2, while convergence plot for loss function is shown in FIG. 12, which is a graphic representation of the number of iterations, in the horizontal axis, required for convergence, in the vertical axis. It may be noted here that the local models used in the approach followed by the embodiments herein were trained only for three iterations at the local nodes. It may be observed from the results shown in Table 2 that conventional FL may not result in improved performance, for example the error has increased from 0.0836 to 0.0841 for cell 2 when FL was applied using the local models trained after three iterations. For either of the cells, the performance was found to be worse than the RMSE obtained by taking the optimally trained local models, that is, the ones whose results are shown in second last column of Table 1, after 15 iterations. However, using the approach followed by the embodiments herein, improvements in performance were observed of 54.41% and 62.79% for Cell 1 and Cell 2, with only three iterations of global model parameter updates. It was also observed, as depicted in FIG. 12, that the loss function rapidly converged in comparison, which alleviated the need to run further iterations. Thus, in comparison, the approach followed by the embodiments herein was able to obtain better performance with a total of only six iterations, three at local and three for the global model, than training the local models for even 15 iterations. These benefits may be understood to account for energy optimization by using the approach followed by the embodiments herein, as computation time and cost are lower, and performance may be improved.

TABLE 2

| | | Our Approach | |
|---|---|---|---|
| | | (Iterations = 3, Local model after 3 | |
| | | iterations) | |
| | Conventional FL | SHAP Global | % RMSE |
| Local Model | Global RMSE | RMSE | improvement |
| Cell 1 | 0.0609 | 0.0277 | 54.41 |
| Cell 2 | 0.0841 | 0.0313 | 62.79 |

Hence, sub-optimal models may be used in the FL approach followed by embodiments herein, and still obtain better performance and efficiency in terms of number of iterations required for convergence of loss.

It may be understood that embodiments herein may be used in different use involving FL in telecommunications. A first such use case may be for the problem of active causal inferencing in real-time network twins for interference root cause identification among cells. Causal inferencing may be understood to involve determining “cause-effect” relationships between predictions of the target by a model and features used to obtain them. A network digital twin may be understood to refer to a computer simulation model of a communication network, along with its operating environment and the application traffic that it may carry. The digital twin may be used to study the behaviour of its physical counterpart under a diverse set of operating conditions. The training of models on radio node software may be centralized, e.g., on a master node, while the execution may be performed in a decentralized way. The global information may be used to train policies for each cell. Post training, each cell may obtain a decentralized policy, which may be implemented based on the local observations of the cell. This architecture may enable the cells to take decisions co-operatively, based on both the local and the global conditions. The local node explainability data may be used according to embodiments herein to effectively train the global models and potentially achieve better performance.

Another non-limiting embodiment may be for the use-case involving model-based hybrid beamforming in Millimetre Wave (mmWave) Multiple Input Multiple Output (MIMO) systems [10]. Here, local beamformers may be designed using model-based manifold optimization algorithms. FL may be used to train a learning model on the local dataset of users, who may estimate the beamformers by feeding the model with their channel data. Explainability may then be leveraged in such a context as well, in a similar manner.

As a summarized overview of the foregoing, embodiments herein may be understood to use explainability of local model(s) to update the model parameters of a global model by using them to compute the loss function. The actions performed may comprise that the local nodes share model parameters M_{C}^{k}(w) and explainability values (S_{C}^{k}) to a central node. The central node may update the model when local node i may report degraded performance (P_{C}ⁱ). Then the central model may be partially updated by loss F computed using explainability values of all local nodes that do not have degraded performance (k≠i), or

$${w}_{( t + 1 )} ← {w}_{t} - η {\sum }_{{k = 1}_{k \neq i}}^{K} {\sum }_{j = 1}^{{n}_{k}} ∇ {F}_{k} ( {S}_{C}^{{k}_{j}} , {y}_{{S}_{C}}^{{k}_{j}} ; {M}_{C}^{{k}_{j}} ( w ) )$$

The loss function used in updating the global model parameters may be determined using the explainability values of the k local model(s) excluding the i^{th} node that reported degradation in performance. The degraded local model may then be replaced by updated w₍ₜ₊₁₎.

One advantage of embodiments herein in FL may be understood to be energy efficiency due to faster convergence of global model loss function in few iterations and improved performance.

Another advantage of embodiments herein may be understood to be that an asynchronous local model update may only be performed when the performance of the model on a target KPI at a cell may degrade, and not irrespective, enabling to learn from model(s) of other cells.

A further advantage of embodiments herein may be understood to be the ability handle drift at the local nodes implicitly. If there is drift, e.g., a change in distribution of training data, e.g., feature KPIs, and that alters local model parameters to degrade its performance, embodiments herein may update the degraded model using the global model that may be updated from explainability values from other local models on that KPI, where performance has not degraded. This may be understood to restore the performance of the local model and redress the ill-effect of drift.

Yet another advantage of embodiments herein may be understood to be that they may enable a selective local model update based on performance, and a periodic global model update, which may allow the global model to frequently switch to a robust model architecture based on performance of the local model(s), redressing the degradation in performance of the models on predicting the target KPI across local node(s).

Furthermore, embodiments herein may advantageously support heterogeneous model topologies at multiple client nodes, since the approach used may be understood to involve updating global model parameters based on a loss function computed on explainability values, and replacing the local model whose performance may have degraded. Different ML model architectures may be supported, such as neural networks, decision trees, graph networks etc. at the nodes. Embodiments herein may be understood to not be restricted to only NNs.

The approach followed by embodiments herein may also be used in additional embodiments involving FL use cases in telecommunications, such as for estimation of coverage at cellular sites where multiple models may be used to determine respective cellular coverage, and may be trained in a federated setup with a model at the tower location, or for predicting pro-active shutdown at cells based on degradation of performance parameters for energy efficiency, or in models used for creating real-time network twins used in capacity planning use cases, or for multi-node causal inference required for traffic analytics, among others [10].

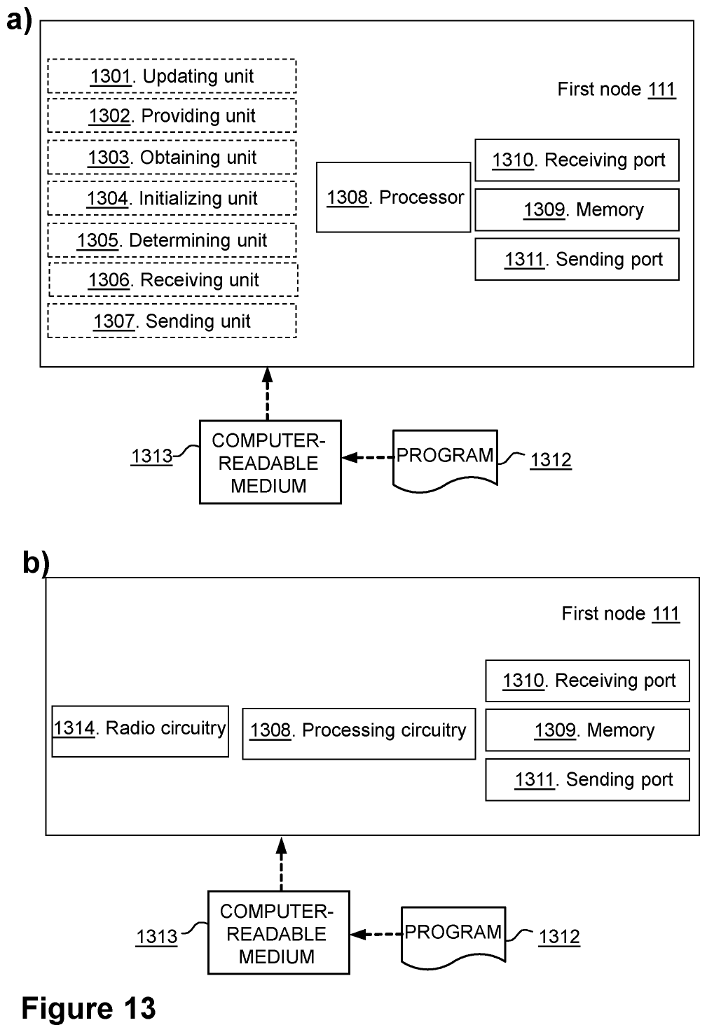

FIG. 13 depicts two different examples in panels a) and b), respectively, of the arrangement that the first node 111 may comprise to perform the method described in FIG. 2, FIGS. 5-9 and/or FIGS. 11-12. In some embodiments, the first node 111 may comprise the following arrangement depicted in FIG. 13a. The first node 111 may be configured to operate in the communications system 100. The first node 111 may be understood to be for handling predictive models.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. In FIG. 13, optional units are indicated with dashed boxes. The detailed description of some of the following corresponds to the same references provided above, in relation to the actions described for the first node 111 and will thus not be repeated here. For example, the explainability values may be configured to be computed using a SHAP explainer.

The first node 111 is configured to, e.g., by means of an updating unit 1301 within the first node 111 configured to, update, using machine learning, the first predictive model of the indicator of performance of the communications system 100. The updating is configured to be based on the respective explainability values configured to be respectively obtained from the first subset of the plurality of second nodes 112 configured to be operating in the communications network 100. The respective explainability values are configured to correspond to the first subset of the respective second predictive models of the indicator of performance of the communications system 100, configured to be respectively determined by the first subset of the plurality of second nodes 112. The models in the first subset of respective second predictive models are configured to have the respective performance value above the threshold.

The first node 111 is further configured to, e.g., by means of a providing unit 1302 within the first node 111 configured to, provide the indication of the first predictive model configured to be updated to the third node 113 configured to be comprised in the plurality of second nodes 112 and excluded from the first subset, or to another node 114 configured to operate in the communications system 100.

In some embodiments, the updating may be configured to comprise refraining from updating the first predictive model with the respective explainability values configured to correspond to the second subset of respective second predictive models of the indicator of performance of the communications system 100, configured to be respectively determined by the second subset of the plurality of second nodes 112. The models in the second subset of respective second predictive models may be configured to have the respective performance value below the threshold.

In some embodiments, the first node 111 may be further configured to, prior to the updating of the first predictive model, e.g., by means of an obtaining unit 1303 within the first node 111 configured to, obtain, from each of the second nodes in the plurality of second nodes 112, as obtained after the first number of iterations of training the respective second predictive models, respectively, by the plurality of second nodes 112: i) the first respective parameters of the first version of the respective second predictive models, ii) the first respective indicators of performance of the first version of the respective second predictive models, and iii) the first respective explainability values of the first version of the respective second predictive models.

In some embodiments, the first node 111 may be further configured to, prior to the updating of the first predictive model, e.g., by means of an initializing unit 1304 within the first node 111 configured to, initialize the first predictive model with the first version of one of the respective second predictive models. The first version of the one of the respective second predictive models may be configured to correspond to the best performing model of the first version of the respective second predictive models after the first number of iterations of training of the first version of the respective second predictive models.

In some embodiments, the first node 111 may be further configured to, e.g., by means of a determining unit 1305 within the first node 111 configured to, determine that the update to the first predictive model is to be performed, based on the degradation configured to be detected of the second version of the one of the respective second predictive models. The updating may be configured to be performed based on the result of the determination that the update is to be performed.

In some embodiments, the first node 111 may be further configured to, e.g., by means of a receiving unit 1306 within the first node 111 configured to, receive the first indication from the third node 113. The first indication may be configured to request the update of the second version of the respective second predictive model of the third node 113. The requested update may be configured to be due to is detected degradation of the second version of the respective second predictive model of the third node 113. The determining may be configured to be based on the first indication configured to be received.

In some embodiments, the first node 111 may be further configured to, e.g., by means of the obtaining unit 1303 within the first node 111 configured to, obtain, from each of the second nodes in the first subset of the plurality of second nodes 112, the respective explainability values as configured to be obtained after the second number of iterations of training the first subset of the respective second predictive models, respectively, by the first subset of the plurality of second nodes 112.

In some embodiments wherein the indication configured to be provided may be configured to be the third indication, the first node 111 may be further configured to, e.g., by means of a sending unit 1307 within the first node 111 configured to, send, to the second nodes in the first subset of the plurality of second nodes 112, the second indication. The second indication may be configured to request to provide the respective explainability values as configured to be obtained after the second number of iterations of training the first subset of the respective second predictive models, respectively, by the first subset of the plurality of second nodes 112. The respective explainability values may be configured to be obtained in response to the second indication configured to be sent.

In some embodiments, the updating may be configured to be performed using the loss function configured to be computed using the respective explainability values.

The embodiments herein in the first node 111 may be implemented through one or more processors, such as a processor 1308 in the first node 111 depicted in FIG. 13a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1309 comprising one or more memory units. The memory 1309 is arranged to be used to store obtained information, store data, configurations, schedulings, and applications etc. to perform the methods herein when being executed in the first node 111.

In some embodiments, the first node 111 may receive information from, e.g., the plurality of second nodes 112, the third node 113, the another node 114 and/or any of the first device 141, the second device 142 and the third device 143 through a receiving port 1310. In some embodiments, the receiving port 1310 may be, for example, connected to one or more antennas in first node 111. In other embodiments, the first node 111 may receive information from another structure in the communications system 100 through the receiving port 1310. Since the receiving port 1310 may be in communication with the processor 1308, the receiving port 1310 may then send the received information to the processor 1308. The receiving port 1310 may also be configured to receive other information.

The processor 1308 in the first node 111 may be further configured to transmit or send information to e.g., the plurality of second nodes 112, the third node 113, the another node 114, any of the first device 141, the second device 142 and the third device 143 and/or another structure in the communications system 100, through a sending port 1311, which may be in communication with the processor 1308, and the memory 1309.

Those skilled in the art will also appreciate that the units 1301-1307 described above may refer to a combination of analog and digital circuits, and/or one or more processors configured with software and/or firmware, e.g., stored in memory, that, when executed by the one or more processors such as the processor 1308, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1301-1307 described above may be implemented as one or more applications running on one or more processors such as the processor 1308.

Thus, the methods according to the embodiments described herein for the first node 111 may be respectively implemented by means of a computer program 1312 product, comprising instructions, i.e., software code portions, which, when executed on at least one processor 1308, cause the at least one processor 1308 to carry out the actions described herein, as performed by the first node 111. The computer program 1312 product may be stored on a computer-readable storage medium 1313. The computer-readable storage medium 1313, having stored thereon the computer program 1312, may comprise instructions which, when executed on at least one processor 1308, cause the at least one processor 1308 to carry out the actions described herein, as performed by the first node 111. In some embodiments, the computer-readable storage medium 1313 may be a non-transitory computer-readable storage medium, such as a CD ROM disc, or a memory stick. In other embodiments, the computer program 1312 product may be stored on a carrier containing the computer program 1312 just described, wherein the carrier is one of an electronic signal, optical signal, radio signal, or the computer-readable storage medium 1313, as described above.

The first node 111 may comprise a communication interface configured to facilitate, or an interface unit to facilitate, communications between the first node 111 and other nodes or devices, e.g., the plurality of second nodes 112, the third node 113, the another node 114, any of the first device 141, the second device 142 and the third device 143 and/or another structure in the communications system 100. The interface may, for example, include a transceiver configured to transmit and receive radio signals over an air interface in accordance with a suitable standard.

In other embodiments, the first node 111 may comprise the following arrangement depicted in FIG. 13b. The first node 111 may comprise a processing circuitry 1308, e.g., one or more processors such as the processor 1308, in the first node 111 and the memory 1309. The first node 111 may also comprise a radio circuitry 1314, which may comprise e.g., the receiving port 1310 and the sending port 1311. The processing circuitry 1308 may be configured to, or operable to, perform the method actions according to FIG. 2, FIGS. 5-9 and/or FIGS. 11-12, in a similar manner as that described in relation to FIG. 13a. The radio circuitry 1314 may be configured to set up and maintain at least a wireless connection with the plurality of second nodes 112, the third node 113, the another node 114, any of the first device 141, the second device 142 and the third device 143 and/or another structure in the communications system 100. Circuitry may be understood herein as a hardware component.

Hence, embodiments herein also relate to the first node 111 operative to operate in the communications system 100. The first node 111 may comprise the processing circuitry 1308 and the memory 1309, said memory 1309 containing instructions executable by said processing circuitry 1308, whereby the first node 111 is further operative to perform the actions described herein in relation to the first node 111, e.g., in FIG. 2, FIGS. 5-9 and/or FIGS. 11-12.

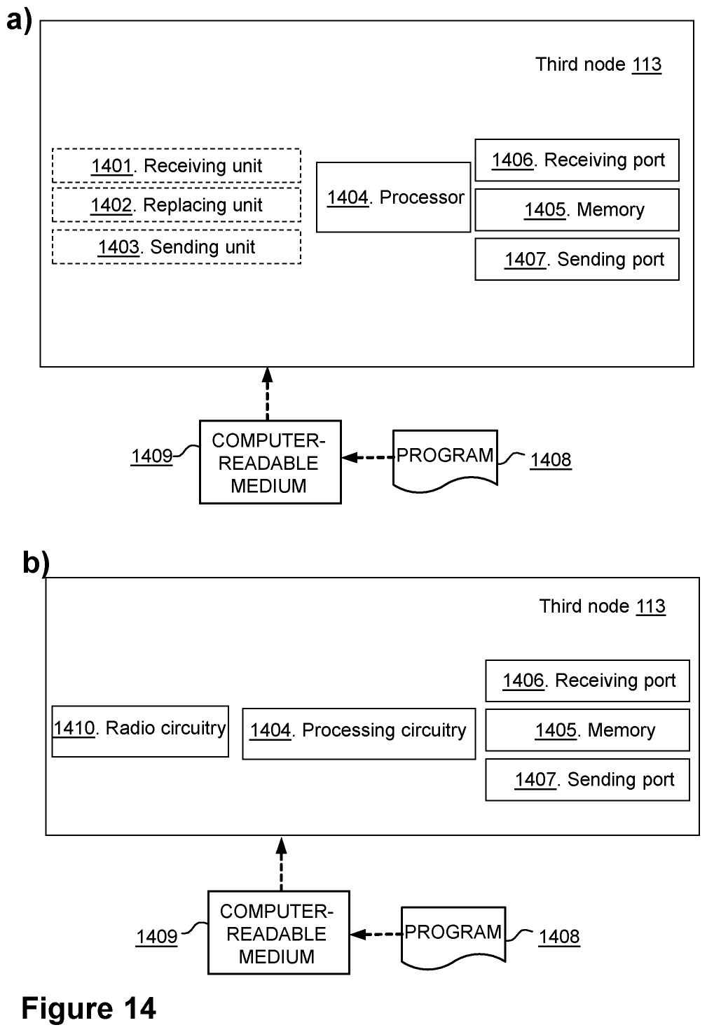

FIG. 14 depicts two different examples in panels a) and b), respectively, of the arrangement that the third node 113 may comprise to perform the method described in FIG. 3, FIGS. 5-9 and/or FIGS. 11-12. In some embodiments, the third node 113 may comprise the following arrangement depicted in FIG. 14a. The third node 113 may be configured to operate in the communications system 100. The third node 113 may be understood to be for handling predictive models.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. In FIG. 14, optional units are indicated with dashed boxes.

The detailed description of some of the following corresponds to the same references provided above, in relation to the actions described for the third node 113 and will thus not be repeated here. For example, the explainability values may be configured to be computed using a SHAP explainer.

The third node 113 is configured to, e.g., by means of a receiving unit 1401 within the third node 113, configured to receive the indication from the first node 111 configured to operate in the communications system 100. The indication is configured to indicate the updated first predictive model of the indicator of performance of the communications system 100. The updated first predictive model is configured to be based on the respective explainability values configured to be respectively obtained from the first subset of the plurality of second nodes 112 configured to operate in the communications network 100. The respective explainability values are configured to correspond to the first subset of respective second predictive models of the indicator of performance of the communications system 100, configured to be respectively determined by the first subset of the plurality of second nodes 112. The models in the first subset of respective second predictive models are configured to have the respective performance value above the threshold. The respective second predictive model of the indicator of performance of the communications system 100 of the third node 113 is configured to have the respective performance value below the threshold. The third node 113 is configured to be comprised in the plurality of second nodes 112 but excluded from the first subset of the plurality of second nodes 112.

The third node 113 is further configured to, e.g., by means of a replacing unit 1402 within the third node 113 configured to, replace the respective second predictive model of the indicator of performance of the communications system 100 of the second node 112 with the updated first predictive model configured to be indicated by the indication configured to be received.

In some embodiments wherein the indication configured to be received may be configured to be the third indication, the third node 113 may be further configured to, prior to the receiving of the third indication, e.g., by means of a sending unit 1403 within the third node 113 configured to, send, to the first node 111, as configured to be obtained after the first number of iterations of training the respective second predictive model: i) the first respective parameters of the first version of the respective second predictive model, ii) the first respective indicator of performance of the first version of the respective second predictive model, and iii) the first respective explainability values of the first version of the respective second predictive model.

In some embodiments wherein the indication configured to be received may be configured to be the third indication, the third node 113 may be further configured to, e.g., by means of the sending unit 1403 within the third node 113 configured to, send the first indication to the first node 111. The first indication may be configured to request the update of the second version of the respective second predictive model of the third node 113. The requested update may be configured to be due to the detected degradation of the second version of the respective second predictive model of the third node 113. The receiving of the indication may be configured to be based on the first indication configured to be sent.

In some embodiments, the first predictive model may be configured to be the global model, and the respective second predictive models may be configured to be the local models.

The embodiments herein in the third node 113 may be implemented through one or more processors, such as a processor 1404 in the third node 113 depicted in FIG. 14a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1405 comprising one or more memory units. The memory 1405 is arranged to be used to store obtained information, store data, configurations, schedulings, and applications etc. to perform the methods herein when being executed in the third node 113.

In some embodiments, the third node 113 may receive information from, e.g., the first node 111, the plurality of second nodes 112, the another node 114 and/or the first device 141, through a receiving port 1406. In some embodiments, the receiving port 1406 may be, for example, connected to one or more antennas in third node 113. In other embodiments, the third node 113 may receive information from another structure in the communications system 100 through the receiving port 1406. Since the receiving port 1406 may be in communication with the processor 1404, the receiving port 1406 may then send the received information to the processor 1404. The receiving port 1406 may also be configured to receive other information.

The processor 1404 in the third node 113 may be further configured to transmit or send information to e.g., the first node 111, the plurality of second nodes 112, the another node 114 and/or the first device 141, and/or another structure in the communications system 100, through a sending port 1407, which may be in communication with the processor 1404, and the memory 1405.

Those skilled in the art will also appreciate that the units 1401-1403 described above may refer to a combination of analog and digital circuits, and/or one or more processors configured with software and/or firmware, e.g., stored in memory, that, when executed by the one or more processors such as the processor 1404, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1401-1403 described above may be implemented as one or more applications running on one or more processors such as the processor 1404.

Thus, the methods according to the embodiments described herein for the third node 113 may be respectively implemented by means of a computer program 1408 product, comprising instructions, i.e., software code portions, which, when executed on at least one processor 1404, cause the at least one processor 1404 to carry out the actions described herein, as performed by the third node 113. The computer program 1408 product may be stored on a computer-readable storage medium 1409. The computer-readable storage medium 1409, having stored thereon the computer program 1408, may comprise instructions which, when executed on at least one processor 1404, cause the at least one processor 1404 to carry out the actions described herein, as performed by the third node 113. In some embodiments, the computer-readable storage medium 1409 may be a non-transitory computer-readable storage medium, such as a CD ROM disc, or a memory stick. In other embodiments, the computer program 1408 product may be stored on a carrier containing the computer program 1408 just described, wherein the carrier is one of an electronic signal, optical signal, radio signal, or the computer-readable storage medium 1409, as described above.

The third node 113 may comprise a communication interface configured to facilitate, or an interface unit to facilitate, communications between the third node 113 and other nodes or devices, e.g., the first node 111, the plurality of second nodes 112, the another node 114 and/or the first device 141, and/or another structure in the communications system 100. The interface may, for example, include a transceiver configured to transmit and receive radio signals over an air interface in accordance with a suitable standard.

In other embodiments, the third node 113 may comprise the following arrangement depicted in FIG. 14b. The third node 113 may comprise a processing circuitry 1404, e.g., one or more processors such as the processor 1404, in the third node 113 and the memory 1405. The third node 113 may also comprise a radio circuitry 1410, which may comprise e.g., the receiving port 1406 and the sending port 1407. The processing circuitry 1404 may be configured to, or operable to, perform the method actions according to FIG. 3, FIGS. 5-9 and/or FIGS. 11-12, in a similar manner as that described in relation to FIG. 14a. The radio circuitry 1410 may be configured to set up and maintain at least a wireless connection with the first node 111, the plurality of second nodes 112, the another node 114 and/or the first device 141, and/or another structure in the communications system 100. Circuitry may be understood herein as a hardware component.

Hence, embodiments herein also relate to the third node 113 operative to operate in the communications system 100. The third node 113 may comprise the processing circuitry 1404 and the memory 1405, said memory 1405 containing instructions executable by said processing circuitry 1404, whereby the third node 113 is further operative to perform the actions described herein in relation to the third node 113, e.g., FIG. 3, FIGS. 5-9 and/or FIGS. 11-12.

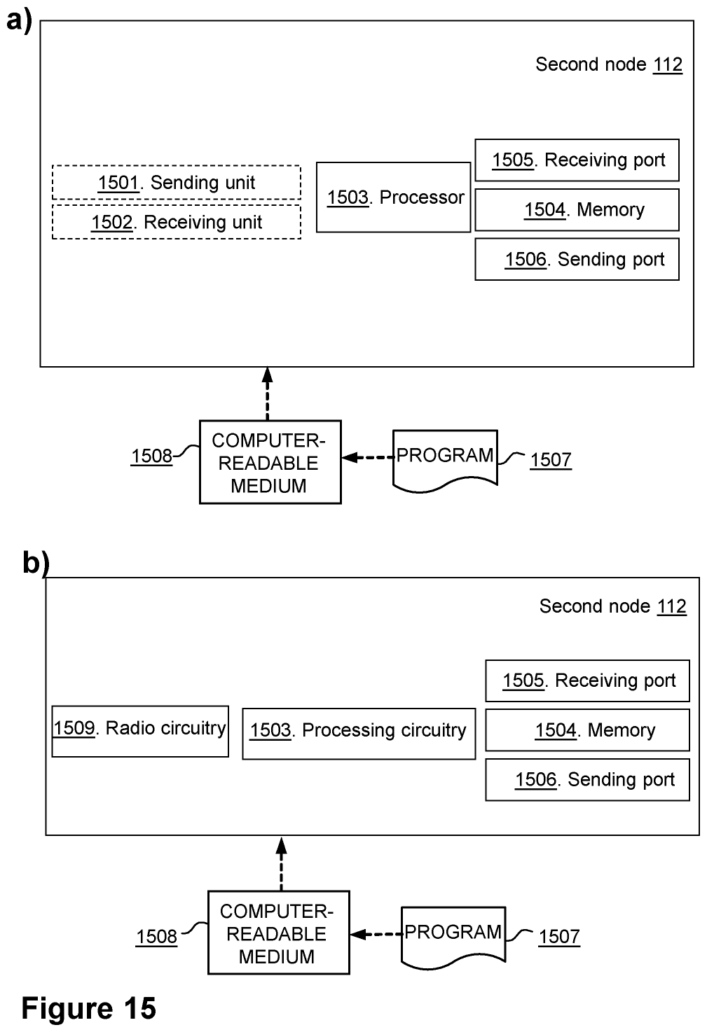

FIG. 15 depicts two different examples in panels a) and b), respectively, of the arrangement that the second node 112 may comprise to perform the method described in FIG. 4, FIGS. 5-9 and/or FIGS. 11-12. In some embodiments, the second node 112 may comprise the following arrangement depicted in FIG. 15a. The second node 112 may be configured to operate in the communications system 100. The second node 112 may be understood to be for handling predictive models.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. In FIG. 15, optional units are indicated with dashed boxes.

The detailed description of some of the following corresponds to the same references provided above, in relation to the actions described for the second node 112 and will thus not be repeated here. For example, the explainability values may be configured to be computed using a SHAP explainer.

The second node 112 is configured to, e.g., by means of a sending unit 1501 within the second node 112 configured to, send, to the first node 111 configured to operate in the communications system 100, the respective explainability values configured to correspond to the respective second predictive model of the indicator of performance of the communications system 100. The respective second predictive model may be configured to have been determined by the second node 112. The respective second predictive model may be configured to have the respective performance value above the threshold.

In some embodiments, the second node 112 may be further configured to, e.g., by means of the sending unit 1501 within the second node 112 configured to, send, to the first node 111, as configured to be obtained after the first number of iterations of training the respective second predictive model: i) the first respective parameters of the first version of the respective second predictive model, ii) the first respective indicator of performance of the first version of the respective second predictive model, and iii) the first respective explainability values of the first version of the respective second predictive model. The respective explainability values may be configured to be obtained after the second number of iterations of training of the respective second predictive model.

In some embodiments, the second node 112 may be further configured to, e.g., by means of a receiving unit 1502 within the second node 112, configured to receive, from the first node 111, the second indication configured to request to provide the respective explainability values as configured to be obtained after the second number of iterations of training the respective second predictive model. The respective explainability values may be configured to be sent in response to the second indication configured to be received.

In some embodiments, the respective second predictive model may be configured to be a local model.

The embodiments herein in the second node 112 may be implemented through one or more processors, such as a processor 1503 in the second node 112 depicted in FIG. 15a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1504 comprising one or more memory units. The memory 1504 is arranged to be used to store obtained information, store data, configurations, schedulings, and applications etc. to perform the methods herein when being executed in the second node 112.

In some embodiments, the second node 112 may receive information from, e.g., the first node 111, the other second nodes in the plurality of second nodes 112, the third node 113, the another node 114 and/or any of the second device 142 and the third device 143, through a receiving port 1505. In some embodiments, the receiving port 1505 may be, for example, connected to one or more antennas in second node 112. In other embodiments, the second node 112 may receive information from another structure in the communications system 100 through the receiving port 1505. Since the receiving port 1505 may be in communication with the processor 1503, the receiving port 1505 may then send the received information to the processor 1503. The receiving port 1505 may also be configured to receive other information.

The processor 1503 in the second node 112 may be further configured to transmit or send information to e.g., the first node 111, the other second nodes in the plurality of second nodes 112, the third node 113, the another node 114 and/or any of the second device 142 and the third device 143 and/or another structure in the communications system 100, through a sending port 1506, which may be in communication with the processor 1503, and the memory 1504.

Those skilled in the art will also appreciate that the units 1501-1502 described above may refer to a combination of analog and digital circuits, and/or one or more processors configured with software and/or firmware, e.g., stored in memory, that, when executed by the one or more processors such as the processor 1503, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1501-1502 described above may be implemented as one or more applications running on one or more processors such as the processor 1503.

Thus, the methods according to the embodiments described herein for the second node 112 may be respectively implemented by means of a computer program 1507 product, comprising instructions, i.e., software code portions, which, when executed on at least one processor 1503, cause the at least one processor 1503 to carry out the actions described herein, as performed by the second node 112. The computer program 1507 product may be stored on a computer-readable storage medium 1508. The computer-readable storage medium 1508, having stored thereon the computer program 1507, may comprise instructions which, when executed on at least one processor 1503, cause the at least one processor 1503 to carry out the actions described herein, as performed by the second node 112. In some embodiments, the computer-readable storage medium 1508 may be a non-transitory computer-readable storage medium, such as a CD ROM disc, or a memory stick. In other embodiments, the computer program 1507 product may be stored on a carrier containing the computer program 1507 just described, wherein the carrier is one of an electronic signal, optical signal, radio signal, or the computer-readable storage medium 1508, as described above.

The second node 112 may comprise a communication interface configured to facilitate, or an interface unit to facilitate, communications between the second node 112 and other nodes or devices, e.g., the first node 111, the other second nodes in the plurality of second nodes 112, the third node 113, the another node 114 and/or any of the second device 142 and the third device 143 and/or another structure in the communications system 100. The interface may, for example, include a transceiver configured to transmit and receive radio signals over an air interface in accordance with a suitable standard.

In other embodiments, the second node 112 may comprise the following arrangement depicted in FIG. 15b. The second node 112 may comprise a processing circuitry 1503, e.g., one or more processors such as the processor 1503, in the second node 112 and the memory 1504. The second node 112 may also comprise a radio circuitry 1509, which may comprise e.g., the receiving port 1505 and the sending port 1506. The processing circuitry 1503 may be configured to, or operable to, perform the method actions according to FIG. 4, FIGS. 5-9 and/or FIGS. 11-12, in a similar manner as that described in relation to FIG. 15a. The radio circuitry 1509 may be configured to set up and maintain at least a wireless connection with the first node 111, the other second nodes in the plurality of second nodes 112, the third node 113, the another node 114 and/or any of the second device 142 and the third device 143 and/or another structure in the communications system 100. Circuitry may be understood herein as a hardware component.

Hence, embodiments herein also relate to the second node 112 operative to operate in the communications system 100. The second node 112 may comprise the processing circuitry 1503 and the memory 1504, said memory 1504 containing instructions executable by said processing circuitry 1503, whereby the second node 112 is further operative to perform the actions described herein in relation to the second node 112, e.g., FIG. 4, FIGS. 5-9 and/or FIGS. 11-12.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. McMahan, Brendan, et al. “Communication-efficient learning of deep networks from decentralized data.” Artificial intelligence and statistics. PMLR, 2017.
2. Manias, Dimitrios Michael, et al. “Concept Drift Detection in Federated Networked Systems.” arXiv preprint arXiv:2109.06088 (2021).
3. Casado, Fernando E., et al. “Concept drift detection and adaptation for federated and continual learning.” arXiv preprint arXiv:2105.13309 (2021).
4. Wang, Guan. “Interpret federated learning with shapley values.” arXiv preprint arXiv:1905.04519 (2019).
5. Lundberg, Scott M., and Su-In Lee. “A unified approach to interpreting model predictions.” Proceedings of the 31st international conference on neural information processing systems. 2017.
6. Francis, Sreya, Irene Tenison, and Irina Rish. “Towards Causal Federated Learning For Enhanced Robustness and Privacy.” arXiv preprint arXiv:2104.06557 (2021).
7. Ribeiro, Marco Tulio, Sameer Singh, and Carlos Guestrin. ““Why should I trust you?” Explaining the predictions of any classifier.” Proceedings of the 22nd ACM SIGKDD international conference on knowledge discovery and data mining. 2016.
8. Li, Junbing, et al. “Deep-LIFT: Deep Label-Specific Feature Learning for Image Annotation.” IEEE Transactions on Cybernetics (2021).
9. Ericsson blogs related to Federated Learning
a. https://www.ericsson.com/en/reports-and-papers/ericsson-technology-review/articles/privacy-aware-machine-learning
b. https://www.ericsson.com/en/blog/2020/2/training-a-machine-learning-model
c. https://www.ericsson.com/en/blog/2021/11/air-quality-prediction-using-machine-learning
10. Elbir, Ahmet M., Sinem Coleri, and Kumar Vijay Mishra. “Federated Dropout Learning for Hybrid Beamforming With Spatial Path Index Modulation In Multi-User mmWave-MIMO Systems.” ICASSP 2021-2021 IEEE International Conference on Acoustics, Speech and Signal Processing (ICASSP). IEEE, 2021.

1. A computer-implemented method, performed by a first node, the method being for handling predictive models, the first node operating in a communications system, the method comprising:
updating, using machine learning, a first predictive model of an indicator of performance of the communications system, the updating being based on respective explainability values respectively obtained from a first subset of a plurality of second nodes operating in the communications network, the respective explainability values corresponding to a first subset of respective second predictive models of the indicator of performance of the communications system, respectively determined by the first subset of the plurality of second nodes, wherein the models in the first subset of respective second predictive models have a respective performance value above a threshold, and
providing an indication of the updated first predictive model to a third node comprised in the plurality of second nodes and excluded from the first subset, or to another node operating in the communications system.

2. The method of claim 1, wherein the updating comprises refraining from updating the first predictive model with respective explainability values corresponding to a second subset of respective second predictive models of the indicator of performance of the communications system, respectively determined by a second subset of the plurality of second nodes, wherein the models in the second subset of respective second predictive models have the respective performance value below the threshold.

3. The method of claim 1, further comprising, prior to the updating of the first predictive model:
obtaining, from each of the second nodes in the plurality of second nodes, as obtained after a first number of iterations of training the respective second predictive models, respectively, by the plurality of second nodes:
a) first respective parameters of a first version of the respective second predictive models,
b) first respective indicators of performance of the first version of the respective second predictive models, and
c) first respective explainability values of the first version of the respective second predictive models, and
initializing the first predictive model with the first version of one of the respective second predictive models, wherein the first version of the one of the respective second predictive models corresponds to the best performing model of the first version of the respective second predictive models after the first number of iterations of training of the first version of the respective second predictive models.

4. The method according to claim 1, further comprising:
determining that the update to the first predictive model is to be performed, based on a detected degradation of a second version of one of the respective second predictive models, and wherein the updating is performed based on a result of the determination that the update is to be performed.

5. The method according to claim 4, wherein the method further comprises:
receiving a first indication from the third node, the first indication requesting an update of a second version of the respective second predictive model of the third node, the requested update being due to a detected degradation of the second version of the respective second predictive model of the third node, and wherein the determining is based on the received first indication.

6. The method according to claim 1, further comprising:
obtaining, from each of the second nodes in the first subset of the plurality of second nodes, the respective explainability values as obtained after a second number of iterations of training the first subset of the respective second predictive models, respectively, by the first subset of the plurality of second nodes.

7. The method according to claim 1, wherein the provided indication is a third indication and wherein the method further comprises:
sending, to the second nodes in the first subset of the plurality of second nodes, a second indication, the second indication requesting to provide the respective explainability values as obtained after a second number of iterations of training the first subset of the respective second predictive models, respectively, by the first subset of the plurality of second nodes, and wherein the respective explainability values are obtained in response to the sent second indication.

8. The method according toy claim 1, wherein the updating is performed using a loss function computed using the respective explainability values.

9. A computer-implemented method, performed by a third node, the method being for handling predictive models, the third node operating in a communications system, the method comprising:
receiving an indication from a first node operating in the communications system, the indication indicating an updated first predictive model of an indicator of performance of the communications system, the updated first predictive model being based on respective explainability values respectively obtained from a first subset of a plurality of second nodes operating in the communications network, the respective explainability values corresponding to a first subset of respective second predictive models of the indicator of performance of the communications system, respectively determined by the first subset of the plurality of second nodes, wherein the models in the first subset of respective second predictive models have a respective performance value above a threshold, wherein a respective second predictive model of the indicator of performance of the communications system of the third node has a respective performance value below the threshold and, wherein the third node is comprised in the plurality of second nodes but excluded from the first subset of the plurality of second nodes, and
replacing the respective second predictive model of the indicator of performance of the communications system of the third node with the updated first predictive model indicated by the received indication.

10. The method of claim 9, wherein the indication is a third indication, and wherein the method further comprises, prior to the receiving of the third indication:
sending, to the first node, as obtained after a first number of iterations of training the respective second predictive model:
a) first respective parameters of a first version of the respective second predictive model,
b) a first respective indicator of performance of the first version of the respective second predictive model, and
c) first respective explainability values of the first version of the respective second predictive model.

11. The method according to claim 9, wherein the received indication is a third indication and wherein the method further comprises:
sending a first indication to the first node, the first indication requesting an update of a second version of the respective second predictive model of the third node, the requested update being due to a detected degradation of the second version of the respective second predictive model of the third node, and wherein the receiving of the indication is based on the sent first indication.

12. The method according to claim 9, wherein the first predictive model is a global model, and the respective second predictive models are local models.

13. A computer-implemented method, performed by a second node, the method being for handling predictive models, the second node operating in a communications system, the method comprising:
sending, to a first node operating in the communications system, respective explainability values corresponding to a respective second predictive model of an indicator of performance of the communications system, the respective second predictive model having been determined by the second node and wherein the respective second predictive model has a respective performance value above a threshold.

14. The method of claim 13, further comprising:
sending, to the first node, as obtained after a first number of iterations of training the respective second predictive model:
a) first respective parameters of a first version of the respective second predictive model,
b) a first respective indicator of performance of the first version of the respective second predictive model, and
c) first respective explainability values of the first version of the respective second predictive model, and
wherein the respective explainability values are obtained after a second number of iterations of training of the respective second predictive model.

15. The method according to claim 13, further comprising:
receiving, from the first node, a second indication requesting to provide the respective explainability values as obtained after a second number of iterations of training the respective second predictive model, and wherein the respective explainability values are sent in response to the received second indication.

16. The method according to claim 13, wherein the respective second predictive model is a local model.

17. A first node, for handling predictive models, the first node being configured to operate in a communications system, the first node being further configured to perform a method according to claim 1.

18.-24. (canceled)

25. A third node, for handling predictive models, the third node being configured to operate in a communications system, the third node being further configured to perform a method according to claim 9.

26.-28. (canceled)

29. A second node, for handling predictive models, the second node being configured to operate in a communications system, the second node being further configured to perform a method according to claim 13.

30.-32. (canceled)

33. A computer program product comprising a non-transitory computer readable medium storing a computer program comprising instructions which, when executed on processing circuitry, cause the processing circuitry to carry out the method according to claim 1.
